(19) United States
(12) Patent Application Publication
(10) Pub. No.: US 2013/0299688 A1
(43) Pub. Date: Nov. 14, 2013

(54) TECHNIQUES FOR ANALYZING MASS SPECTRA FROM THERMAL DESORPTION RESPONSE

(71) Applicants: Michael P. BALOGH, Rehoboth, MA (US); Marc V. Gorenstein, Needham, MA (US); Marian Twohig, Douglas, MA (US)

(72) Inventors: Michael P. BALOGH, Rehoboth, MA (US); Marc V. Gorenstein, Needham, MA (US); Marian Twohig, Douglas, MA (US)

(21) Appl. No.: 13/469,613

(22) Filed: May 11, 2012

(51) Int. Cl. H01J 49/16

(52) U.S. Cl. 250/282; 250/281

(57) ABSTRACT

Techniques are described for sample analysis. Thermal desorption of components of the sample occurs at atmospheric pressure at a plurality of times by applying one of a plurality of temperatures included in a temperature gradient at each of the times to a surface of the sample. Desorption of each component occurs at a different temperature thereby allowing differentiation of the components based on one of the times corresponding to the temperature at which desorption occurs for the component. Ions are generated from the thermally desorbed components. Mass spectra generated from the ions are analyzed to determine mass spectral features about the components. Analyzing includes associating one of the ions with a component if the one ion has an ion intensity apex or peak that is detected in the mass spectra and occurs at a time corresponding to a one of the temperatures at which thermal desorption occurs for the component.

### TECHNICAL FIELD

This application generally relates to techniques for use with analyses of samples, and, more particularly, to instruments and methods for analyzing mass spectra.

### BACKGROUND INFORMATION

Mass spectrometry (MS) is used widely for identifying and quantifying molecular species in a sample. During analysis, molecules from the sample are ionized to form ions. A detector produces a signal relating to the mass of the molecule and charge carried on the molecule and a mass-to-charge ratio (m/z) for each of the ions is determined.

A chromatographic separation technique may be performed prior to injecting the sample into a mass spectrometer. Chromatography is a technique for separating compounds, such as those held in solution, where the compounds will exhibit different affinity for a separation medium in contact with the solution. As the solution flows through such an immobile medium, the compounds separate from one another. Common chromatographic separation instruments include gas chromatographs (GC) and liquid chromatographs (LC). When coupled to a mass spectrometer, the resulting systems are referred to as GC/MS or LC/MS systems. GC/MS or LC/MS systems are typically on-line systems in which the output of the GC or LC is coupled directly to the MS.

In an LC/MS system, a sample is injected into the liquid chromatograph at a particular time. The liquid chromatograph causes the sample to elute over time resulting in an eluent that exits the liquid chromatograph. The eluent exiting the liquid chromatograph is continuously introduced into the ionization source of the mass spectrometer. As the separation progresses, the composition of the mass spectrum generated by the MS evolves and reflects the changing composition of the eluent.

Typically, at regularly spaced time intervals, a computer-based system samples and records the spectrum. The response (or intensity) of an ion is the height or area of the peak as may be seen in the spectrum. The spectra generated by conventional LC/MS systems may be further analyzed. Mass or mass-to-charge (m/z) ratio estimates for an ion are derived through examination of a spectrum that contains the ion. Retention time estimates for an ion are derived by examination of a chromatogram that contains the ion.

Two stages of mass analysis (MS/MS also referred to as tandem mass spectrometry) may also be performed. One particular mode of MS/MS is known as product ion scanning where parent or precursor ions of a particular m/z value are selected in the first stage of mass analysis by a first mass filter/analyzer. The selected precursor ions are then passed to a collision cell where they are fragmented to produce product or fragment ions. The product or fragment ions are then mass analyzed by a second mass filter/analyzer.

### SUMMARY OF THE INVENTION

In accordance with one aspect of the invention is a method of performing sample analysis. Thermal desorption of components of the sample occur at atmospheric pressure at a plurality of times by applying one of a plurality of temperatures included in a temperature gradient at each of the plurality of times to a surface of the sample. Desorption of each of the components occurs at a different one of the plurality of temperatures thereby allowing differentiation of the components based on one of the plurality of times corresponding to the different one of the temperatures at which desorption occurs for each component. Ions are generated from the thermally desorbed components. Mass spectra are generated from the ions. The mass spectra are analyzed to determine mass spectral features about the components. Analyzing includes associating one of the ions with one of the components if the ion has an ion intensity apex or peak that is detected in the mass spectra and occurs at a first of the plurality of times corresponding to a first of the plurality of temperatures at which thermal desorption occurs for the one component. The method may also include determining that two of the ions are associated with one another and originate from the same component if the two ions have ion intensity peaks occurring at a same one of the plurality of times. The two ions may have ion intensity peaks having similar shapes. The step of analyzing may also include determining peaks in the mass spectra wherein each of the peaks corresponds to a detected ion of the sample. Each of the peaks may have associated identifying characteristics including an ion intensity, an m/z or mass, and one of the plurality of times corresponding to one of the plurality of temperatures at which the peak is determined The method may further include performing ion mobility spectrometry and each of the peaks may include a measurement of each peak in an ion mobility dimension. The mass spectra may be uniformly sampled in time. The mass spectra may be generated by perform mass spectrometry without performing a separation technique prior to causing thermal desorption of components. The sample may include any of a complex mixture, a solid, a tissue, and a liquid. The sample may include one or more proteins where each of the proteins is identified by a first set of one or more precursor ions and a second set of one or more product ions generated from a precursor ion of the first set. Each of the ions in the first set and the second set may have an ion intensity peak at a same one of the plurality of times corresponding to one of the plurality of temperatures. The thermal desorption may be performed using an atmospheric pressure ionization technique. The atmospheric pressure ionization technique may include any of atmospheric pressure chemical ionization and atmospheric pressure photoionization. The thermal desorption may be performed using a stream of a heated gas followed by subsequent ionization of desorbed components by means of a corona discharge established in a chamber in which a surface bearing the components is disposed. If a first component of the sample desorbs at a first of the plurality of temperatures, all ions originating from the component may have an ion intensity peak or apex response at one of the plurality of times corresponding to the first temperature. The method may include determining that a portion of the ions are related to one of the components wherein each ion of the portion has an ion intensity peak at a same one of the plurality of times. Each of the components may be desorbed in the time sequence at its characteristic temperature. The mass spectra may be generated by performing analysis of the ions including performing mass spectrometry. Ion mobility spectrometry may be performed in connection with the ions prior to performing mass spectrometry. The plurality of temperatures of the thermal gradient may define a range from a starting first temperature to an ending second temperature and the first temperature may be less than the second temperature. An exposed surface of the sample may be subject to the plurality of temperatures from the starting first temperature at a first point in time to the ending second temperature at a second point in time subsequent to the first point in time. The plurality of temperatures of the thermal gradient may define a range from a starting first temperature to an ending second temperature and the first temperature may be more than the second temperature where an exposed surface of the sample is subject to the plurality of temperatures from the starting first temperature at a first point in time to the ending second temperature at a second point in time subsequent to the first point in time. Thermal desorption may be performed using a laser to cause desorption of components in the sample followed by subsequent ionization of desorbed components.

In accordance with another aspect of the invention is a system for sample analysis. The system includes means for causing thermal desorption of components of the sample at atmospheric pressure at a plurality of times by applying one of a plurality of temperatures included in a temperature gradient at each of the plurality of times to a surface of the sample. Desorption of each of the components occurs at a different one of the plurality of temperatures thereby allowing differentiation of the components based on one of the plurality of times corresponding to the different one of the temperatures at which desorption occurs for each component. The system also includes means for generating ions from the thermally desorbed components, means for generating mass spectra from the ions, and means for analyzing the mass spectra to determine mass spectral features about the components. Analyzing the mass spectra includes associating one of the ions with one of the components if the one ion has an ion intensity apex or peak that is detected in the mass spectra and occurs at a first of the plurality of times corresponding to a first of the plurality of temperatures at which thermal desorption occurs for the one component. The means for thermal desorption may cause desorption using a gas having its temperature varied over time in accordance with the thermal gradient. The means for generating ions may use an atmospheric pressure ionization technique. The means for generating mass spectra may include a component that performs mass analysis. The means for generating mass spectra may include a component that performs ion mobility spectrometry prior to mass analysis. The system may include means for introducing a sample for analysis. The means for introducing a sample may include any of a probe and a sample holder. The means for thermal desorption may cause desorption using a laser to provide different desorption temperatures varied over time in accordance with the thermal gradient.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIGS. 1 and 7-10 are examples of components that may be included in a system in an embodiment in accordance with techniques herein;

FIGS. 2-6 are examples of mass spectra that may be generated and processed in an embodiment in accordance with techniques herein;

FIGS. 11-12 are flowcharts of processing steps that may be performed in an embodiment in accordance with techniques herein; and

FIG. 13 shows three related graphs, which illustrate the collection of mass spectra as may be performed in an embodiment in accordance with techniques herein.

### DESCRIPTION

As used herein, the following terms generally refer to the indicated meanings:

“Chromatography” —refers to equipment and/or methods used in the separation of chemical compounds. Chromatographic equipment typically moves fluids and/or ions under pressure and/or electrical and/or magnetic forces. The word “chromatogram,” depending on context, herein refers to data or a representation of data derived by chromatographic means. A chromatogram can include a set of data points, each of which is composed of two or more values; one of these values is often a chromatographic retention time value, and the remaining value(s) are typically associated with values of intensity or magnitude, which in turn correspond to quantities or concentrations of components of a sample.

A sample may refer to the composition, mixture, solution, material, solid, tissue, or more generally, any substance, which is to be analyzed. In connection with techniques herein, the sample may contain one or more compounds, analytes, or components of interest. A sample or compound of interest may generally be, or include, any molecule including, for example, a small molecule, such as an organic compound, metabolite, and organic compounds, as well as a larger molecule such as a protein.

Retention time—in context, typically refers to the point in a chromatographic profile at which an entity reaches its maximum intensity.

Ions—A compound or component of a sample that is typically detected using the mass spectrometer (MS) appears in the form of ions in data generated as a result of performing an experiment such as in an LC/MS or GC/MS system. An ion has, for example, a retention time and an m/z value. The LC/MS or GC/MS system may be used to perform experiments and produce a variety of observed measurements for every detected ion. This includes: the mass-to-charge ratio (m/z), mass (m), the retention time, and the signal intensity of the ion, such as a number of ions counted. In following paragraphs and descriptions, reference may be made to a particular system and components including an MS for purposes of illustration.

Generally, an LC/MS system may be used to perform sample analysis and may provide an empirical description of, for example, a protein or peptide as well as a small molecule such as a pharmaceutical or herbicide in terms of its mass, charge, retention time, and total intensity. When a molecule elutes from a chromatographic column, it elutes over a specific retention time period and reaches its maximum signal at a single retention time. After ionization and (possible) fragmentation such as in connection with perform mass spectrometry, the compound appears as a related set of ions.

In an LC/MS separation, a molecule may be produced in a single or multiple charged states. MS/MS may also be referred to as tandem mass spectrometry which can be performed in combination with LC separation (e.g., denoted LC/MS/MS).

As an output, the MS generates a series of spectra or scans collected over time. A mass-to-charge spectrum is intensity plotted as a function of m/z. Each element, a single mass-to-charge ratio, of a spectrum may be referred to as a channel. Viewing a single channel over time provides a chromatogram for the corresponding mass-to-charge ratio. Analysis of the mass spectra permits measurement of an accurate retention time value for both the eluted precursor and its associated product(s) or fragment(s). Moreover, for example, peak shape, width, and/or retention time of the peaks associated with precursor ions and with product ions may be compared to determine which product ions are associated with a particular precursor ion. The product ions are associated with their precursor ion in response to matching retention-time values and/or other characteristics such as chromatographic peak profile or shape as described elsewhere herein. Furthermore and more generally, ions (precursors and associated product or fragment ions) derived from a common originating molecule (e.g. component or compound in a sample) may have a common retention time and/or other similar characteristics. Associating ions having a common retention time is described, for example, in WO 2006/133191, Methods and Apparatus for Performing Retention-Time Matching, Gorenstein et al., (the '191 patent application), which is incorporated by reference herein. Mass spectra obtained using LC/MS may be processed to detect peaks denoting detected ions such as described in WO2005/079263, APPARATUS AND METHOD FOR IDENTIFYING PEAKS IN LIQUID CHROMATOGRAPHY/MASS SPECTROMETRY DATA AND FOR FORMING SPECTRA AND CHROMATOGRAMS, Gorenstein et al., (the '263 patent application), and WO2007/140327, ION DETECTION AND PARAMETER ESTIMATION FOR N-DIMENSIONAL DATA, Gorenstein et al., (“the '327 patent application”), both of which are incorporated by reference herein.

Mass spectrometers can obtain complex spectra from surfaces, in situ liquids and solids, without the benefit of prior sample preparation and/or separation. In the absence of prior separation such as by LC or GC, the generated spectra may be complex especially for complex samples. In accordance with techniques herein, rather than differentiate individual components of the sample by chromatographic separation, since different components in a sample volatilize at different temperatures, the components of sample undergoing analysis may be differentiated based on a thermal gradient separation whereby different points in time are associated with different desorption temperatures. In this manner, an embodiment in accordance with techniques herein may utilize a controlled thermal cycle for the thermal gradient to provide a discrete peak shape in resulting mass spectral data. A time axis of such mass spectra has different points in time corresponding to different characteristic desorption temperatures (rather than retention times) and each component of the sample presents mass spectral features, unique from other components in the sample, at the time point corresponding to the component's characteristic desorption temperature. Mass spectra obtained by performing techniques herein may be processed in a manner similar to that in which mass spectra obtained from an LC/MS experiment are processed. For reference, techniques herein which provide for a dimension of separation based on a thermal gradient (TG) of different desorption temperatures at different points in time in combination with performing mass spectrometry (MS) may be referred to as TG/MS. More generally, as described in more detail below, other separation dimensions, such as ion mobility spectrometry (IMS) that may be coupled with LC and MS (e.g., LC/IMS/MS), may also be used in connection with TG/MS (e.g., TG/IMS/MS). Thus, performing an experiment of a sample using techniques herein such as TG/MS results in the acquisition of mass spectra which may be processed in a manner similar to spectra acquired from a system performing LC and MS. For example, as described in more detail elsewhere herein, mass spectra obtained using TG/MS may be processed to detect peaks denoting detected ions such as described in the '263 patent application and the '327 patent application. Additionally, ions having a common desorption temperature associated with a point in time originate or derive from the same component of the sample in a manner similar to that as described in the '191 patent application with respect to a common retention time whereby such ions having the same retention time are associated and originate from the same component.

In following paragraphs, techniques herein will now be described with reference to exemplary methods and apparatus for analyzing samples. However, generally, the techniques herein may utilize any means or mechanism that causes desorption of components of the sample, differentiated by time, followed by ionization, mass analysis and uniform spectral sampling to provide spectral signatures unique to components of the sample.

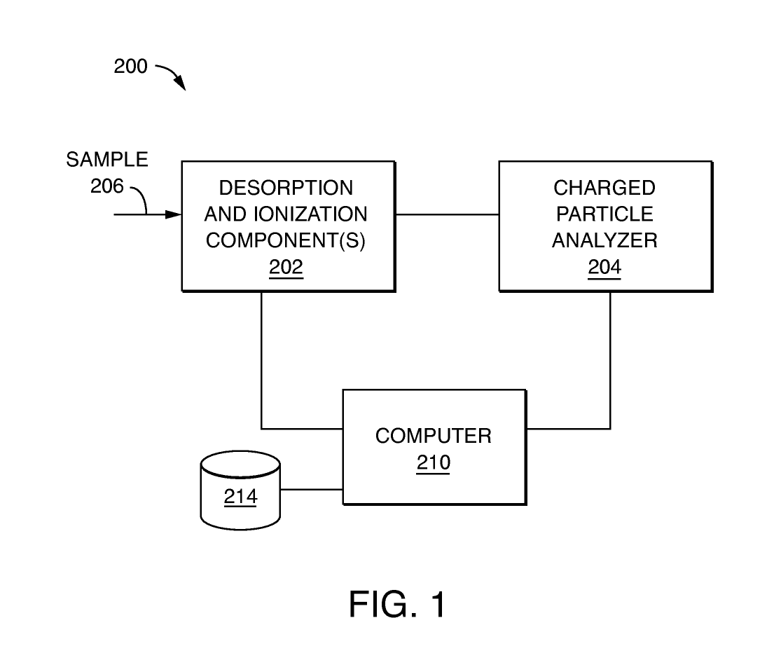

Referring to FIG. 1, shown is an example of components that may be included in a system for use in connection with techniques herein. The sample 206 to be analyzed may be introduced or placed into a desorption and ionization component 202. In some embodiments as described elsewhere herein, desorption may be performed using a hot gas followed by ionization by any suitable means such as those providing for atmospheric pressure ionization (API). The term “atmospheric pressure” is used to distinguish over techniques which are generally regarded in the art as vacuum techniques. The range of pressures encompassed by the term may be from about 100-1500 mbar. In many embodiments the range may be smaller, say from about 500-1200 mbar. In many practical embodiments, the range may be between about 900 and 1100 mbar. Often, the pressure will be that subsisting in the environment of the surface when a pump is not used to reduce the pressure. Examples of API may include, for example, atmospheric pressure chemical ionization (APCI) and atmospheric pressure photo ionization (APPI). Element 202 may be, for example, an ion source of a mass spectrometer (MS) which may be generally characterized as a physical environment in which components of the sample are desorbed and ionized. Subsequently, the ions produced by 202 then enter into the charged particle analyzer 204 for further analysis. In one embodiment, the charged-particle analyzer 204 may be a module that performs mass spectrometry and therefore may include other components of an MS system such as a mass analyzer and detector. As known in the art, a mass spectrometer may include a mass analyzer, which sorts the ions by their masses by applying electromagnetic fields, and a detector, which measures the value of an indicator quantity and thus provides data for calculating the abundances of each ion present (e.g., obtains an ion intensity or quantity for a given mass to charge ratio or m/z value). MS systems are well known and may comprise, by way of example, without limitation, quadrupole(s), time-of-flight or ion trap MS components, preferably having a system of ion guides/and or traps to permit it to receive ions at atmospheric pressure. Thus, the analyzer 204 may include such a module based on any suitable technology for use with techniques herein that performs mass spectrometry as noted above. Additionally, the analyzer 204 may also optionally include a module that performs ion mobility spectrometry (IMS). As known in the art, IMS is an analytical technique used to separate and identify ionized molecules in the gas phase based on their mobility in a carrier buffer gas. Components used in connection with performing IMS and MS systems are well known in the art and available from several vendors such as Waters Corporation of Milford, Mass., USA.

The computer 210 may be any commercially available or proprietary computer system, processor board, ASIC (application specific integrated circuit), or other component which includes a computer processor configured to execute code stored on a computer readable medium. The processor, when executing the code, may cause the computer system 210 to perform processing steps such as to access and analyze the acquired mass spectral data stored on a data storage device 214 (also referred to more generally as a computer readable medium) of the computer system 210, facilitate control and operation of different components in the system 200, and the like. The computer system, processor board, and the like, may be more generally referred to as a computing device. The computing device may also include, or otherwise be configured to access, the storage device 214 comprising executable code stored thereon which cause a computer processor to perform processing steps as described herein. In this manner, the executable code may include instructions for performing analysis of the acquired mass spectral data as described herein.

In operation, the computer 210 may be used to facilitate controlling components of the system 200 to implement a thermal gradient for each sample 206 being analyzed. As described in more detail herein, the computer 210 may include software which is provided with a defined thermal gradient of desorption temperatures whereby the desorption temperature is varied over a time period associated with the thermal gradient (e.g., thermal gradient may range from temperature T1 to temperature T2 over a time period P1 whereby T1 may be less than T2 (representing an increasing desorption temperature gradient) or T1 may be larger than T2 (representing an decreasing desorption temperature gradient)). Although not illustrated, the computer 210 may communicate with an electronic control means which adjusts the temperature of a heating and/or cooling device in the component 202 to suitably vary the desorption temperature in accordance with the desired thermal gradient. The computer 210 may also monitor the current temperature within the component 202 thereby indicating a current desorption temperature based on any suitable temperature sensor (e.g., thermocouple) within 202. An embodiment may utilize a feedback system or technique as known in the art whereby the monitored temperature of the temperature sensor is provided as an input to the computer system 210 which makes appropriate temperature adjustments (e.g., by controlling the heating and/or cooling device(s)) based on a desired target temperature of the thermal gradient thereby affecting the observed temperature.

The generated spectra or scans can be acquired and recorded on the storage device 214 which may be, for example, a hard-disk drive or other storage media represented by accessible to computer 210. Typically, a spectrum or chromatogram is recorded as an array of values and stored on storage 210. The spectra stored on 210 may be accessed using the computer 210 such as for display, subsequent analysis, and the like. A control means (not shown) provides control signals for the various power supplies (not shown) which respectively provide the necessary operating potentials for the components of the system 200. These control signals determine the operating parameters of the instrument. The control means is typically controlled by signals from a computer or processor, such as the computer 210.

The storage device 214 may be any one or more different types of computer storage media and/or devices. As will be appreciated by those skilled in the art, the storage device 214 may be any type of computer-readable medium having any one of a variety of different forms including volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired code, data, and the like, which can accessed by a computer processor.

As noted above, the analyzer 204 may also include components to perform both IMS and MS. The foregoing may be denoted as IMS-MS or IMS/MS for the combination of ion mobility spectrometry and mass spectrometry. Such an analyzer included in a system performing IMS-MS may include first separating ions according to their mobilities (IMS) followed by the mass analyzer separating ions according to their mass to charge (m/z) ratio (e.g., followed by MS). Thus, an embodiment in accordance with techniques herein may provide for separation based on a temperature gradient where different thermal desorption temperatures are associated with different points in time. Such desorption temperature/time separation may be used in combination with MS alone or with IMS-MS. In an embodiment in which desorption temperature separation such as based upon a thermal gradient is used in combination with MS alone, the embodiment may be characterized as performing a multi-dimensional separation based on two properties of ions: desorption temperature (occurring at a particular point in time) and mass to charge (m/z) ratio (from MS). In an embodiment in which desorption temperature separation such as based upon a thermal gradient is used in combination with both IMS and MS, the embodiment may be characterized as performing a multi-dimensional separation based on three properties of ions: desorption temperature (occurring at a particular point in time), ion mobility and mass to charge (m/z) ratio. The ion has an m/z value associated with the ion's peak intensity or abundance at a particular desorption temperature occurring at a point in time. In one aspect, ion intensity (such as associated with the foregoing peak intensity) may also be characterized as another dimension in addition to the above-mentioned separation dimensions. Thus, if one characterizes ion intensity as a dimension of data in addition to the above-mentioned dimensions of separation, the data may be optionally referred to as having a dimension that is one greater than the number of separation dimensions.

Peak detection (used to determine peaks and thus detected ions in mass spectra) in connection with N-Dimensional data such as may be used with LC/IMS/MS and LC/MS is described, for example, in the '327 patent application. In a manner similar to that in which LC retention time is considered a separation dimension in a mass spectra which is processed using a peak detection technique, such as those described in the '327 patent application, the desorption temperature separation (as may be provided using a temperature gradient whereby different desorption temperatures are associated with different points in time) may be used as a separation dimension in connection with peak detection techniques. In other words, the peak detection techniques such as described in the '327 patent application may be used to determine peaks corresponding to detected ions of analyzed mass spectral data obtained using techniques herein whereby desorption temperature separation as denoted by different points in time is substituted in place of the retention time dimension. For example, mass spectral data may be obtained for a sample analyzed as described herein by performing desorption temperature separation in combination with the MS or IMS-MS. Such mass spectral data may be processed using techniques described in the '327 patent application to identify unique mass spectral data associated with particular component(s) of the analyzed sample. Rather than have such mass spectral data include a retention time dimension, the mass spectral data may include a desorption temperature dimension such as may be expressed using a time axis denoting different points in time each associated with a desorption temperature. In one embodiment, a series of points in time may correspond to different desorption temperatures of a thermal gradient. Using the techniques of the '327 patent application to analyze such mass spectra, each detected ion is characterized by various characteristics or parameters and has an ion intensity peak or apex at a point in time. In connection with techniques herein, the foregoing point in time at which the ion intensity peak or apex occurs is associated with a desorption temperature at the point in time rather than a retention time (such as with LC/MS systems). Parameters optionally used to characterize a peak profile of a given ion may include the time of initial detection (liftoff), normalized slope, the time of inflection points relative to the time of the peak apex, the time of maximum response (peak apex), the peak width, at inflection points, at full-width-at-half-maximum (FWHM), peak shape asymmetry, and the time of the final detection (touch down) to name only a few. All ions in the mass spectral data having a detected ion intensity peak or apex at a point in time associated with the same desorption temperature may be determined as associated or related in that such ions derive or originate from the same common component of the sample. In this manner, all ions of the same component have the same desorption temperature (within some threshold or expected error tolerance) and thus may be characterized as ions that temperature-align (based on common desorption temperature) in a manner similar to that in which all such ions originating from the same component share a common retention time. More generally, the techniques described herein which perform separation based on different desorption temperatures and where ions originating from the same component in a sample have the same desorption temperature may be used in a manner similar to techniques used in connection with retention time such as described, for example, in the '191 patent application.

The inventors performed experiments regarding feasibility of the techniques herein for TG/MS. Some of the results of such experimentation will now be described.

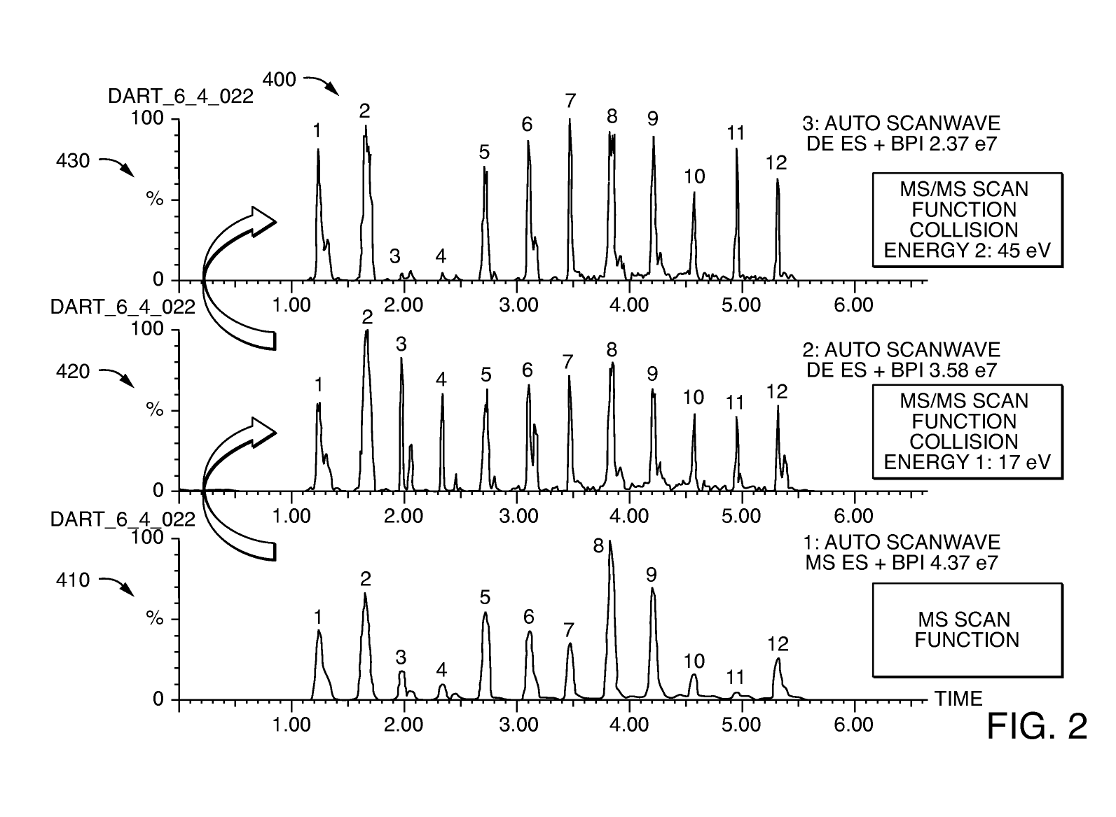

Referring to FIG. 2, shown is an example of MS spectral scan data obtained in connection with experimentation performed by the inventors. The experiments were performed using the Xevo™ TQ MS and an ASAP probe, both commercially available from Waters Corporation of Milford, Mass. Using an ASAP probe with MS allows for direct analysis of samples using an atmospheric pressure ionization (API) source found on LC/MS instruments. The ASAP probe permits fast analysis of a sample that includes any of a solid, a liquid, a tissue, or any other material. In operation, the sample is placed on the probe. The probe is then inserted directly into the ion source thereby introducing the sample into the ion source. The ion source then causes components in the sample to desorb through application of a heated gas jet applied directly to the sample followed by ionization by an API source. In connection with the experiments performed by the inventors for 12 (twelve samples), each sample was coated on a melting point capillary of the ASAP probe which was introduced into the ion source whereby the sample was thermally desorbed in the presence of metastable ions generated by an APCI technique without prior separation. The ion source used was by IonSense which provided for direct analysis in real time (DART) at atmospheric or ambient pressure.

In connection with the experiments performed to generate the spectra of FIG. 2, it should be noted that in effect, the probe insertion into the MS for each sample results in a temperature gradient from ambient temperature to an increased temperature of the ion source. Thus, curves of the mass spectral data generated for a sample represent a desorption temperature gradient where the front or first portions of a curve (or mass spectra obtained during analysis of the sample) coincide with the lower desorption temperature which increases with time. The most volatile components of the sample volatilize and desorb prior to other component(s) of the sample having a higher desorption temperature appearing subsequent in time. The MS instrument was run in survey scan mode which switches from LC/MS to LC/MS/MS data acquisition in the same run to respectively acquire data in a first or low collision energy mode (e.g., 17 eV) and then a second or a high collision energy mode (e.g. 45 eV). In this manner, the scans 410, 420 and 430 were all acquired in the same single run for the 12 samples. Element 410 represents the original survey scan for ions of all, or a broad range of, m/z's. The MS/MS function to acquire data as in 420 (for low collision energy) and 430 (for the high collision energy) is triggered when a specified threshold intensity is reached in the original survey scan 410. As known in the art and described elsewhere herein, low collision energy mode may be used to primarily obtain scan data for precursor ions and high collision energy mode may be used to primarily obtain scan data for product ions generated by further fragmentation of the precursor ions. In connection with the scans 410, 420 and 430, the x axis represents the progression of time during which data for each of the 12 samples was acquired, and the y axis represents a relative ion intensity or abundance in terms of relative percentages for the different samples analyzed in succession using the ASAP probe. Data of the scans 410, 420 and 430 acquired in connection with each of the 12 samples is denoted by a corresponding number 1 through 12 near the curve or graphical data for the sample.

Sample 1 was a sibutramine standard (anorectic and USDEA Schedule IV controlled substance). Sample 3 was a sildenafil standard (e.g. active pharmaceutical ingredient for Viagra™). Samples 5-12 were found to be adulterated with Sibutramine and some had other adulterants including phenolphthalein and caffeine. Data such as that illustrated in connection with FIG. 2 may be processed, for example using peak detection techniques such as described in the '263 and '327 patent applications.

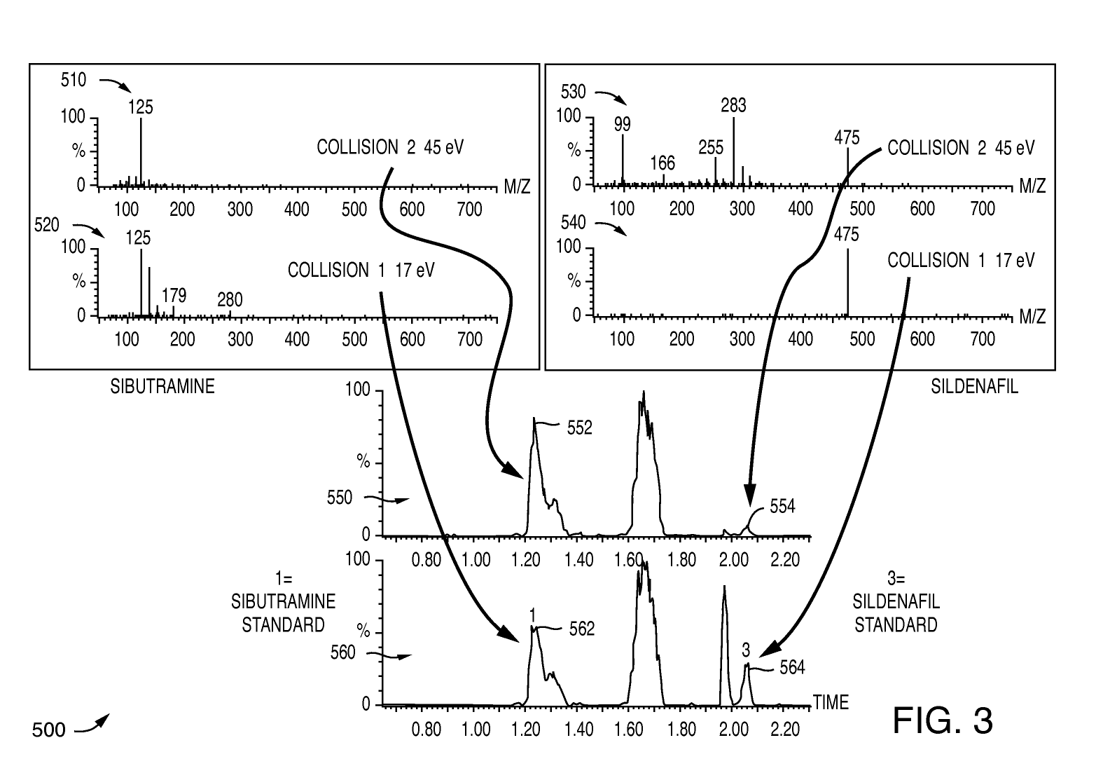

Referring to FIG. 3, shown is additional scan data in connection with portions of the scans from FIG. 2. Element 560 denotes a portion of the scan 420 enlarged for 1-3 for the lower collision energy. Element 550 denotes a portion of the scan 430 enlarged for samples 1-3 for the higher collision energy. In connection with the illustrated data of 550 and 560, it should be noted that reproducible separation between peaks corresponding to different components of the samples 1 and 3 is visible.

Elements 552 and 562 denote peaks in connection with spectra acquired for sample 1, sibutramine standard. Peaks 552 and 562 were observed and further data analysis performed for data selected as being included in the peak. The further analysis of the foregoing peak data is illustrated in 510 and 520. Element 510 represents the average intensity for the illustrated m/z values for the width of the peak 552 in connection with data acquired in scan 430 (high collision energy 45 eV). Element 520 represents the average intensity for the illustrated m/z values for the width of the peak 562 in connection with data acquired in scan 420 (low collision energy 17 eV). As noted above, sample 1 contains sibutramine which has a monoisotopic mass of 279.175378 Da. In the illustrations 510 and 520, the presence of a standard sibutramine signature fragment for m/z=125 is observed as having a large response or ion intensity.

Elements 554 and 564 denote peaks in connection with spectra acquired for sample 3, sildenafil standard. Peaks 554 and 564 were observed and further data analysis performed for data selected as being included in the peak. The further analysis of the foregoing peak data is illustrated in 530 and 540. Element 530 represents the average intensity for the illustrated m/z values for the width of the peak 554 in connection with data acquired in scan 430 (high collision energy 45 eV). Element 540 represents the average intensity for the illustrated m/z values for the width of the peak 564 in connection with data acquired in scan 420 (low collision energy 17 eV). As noted above, sample 3 contains sildenafil which has a monoisotopic mass of 474.204923 Da. In the illustrations 530, 540, the presence of standard sildenafil signature fragments for m/z's of 283, 99 and 255 may be observed as having large responses or ion intensities.

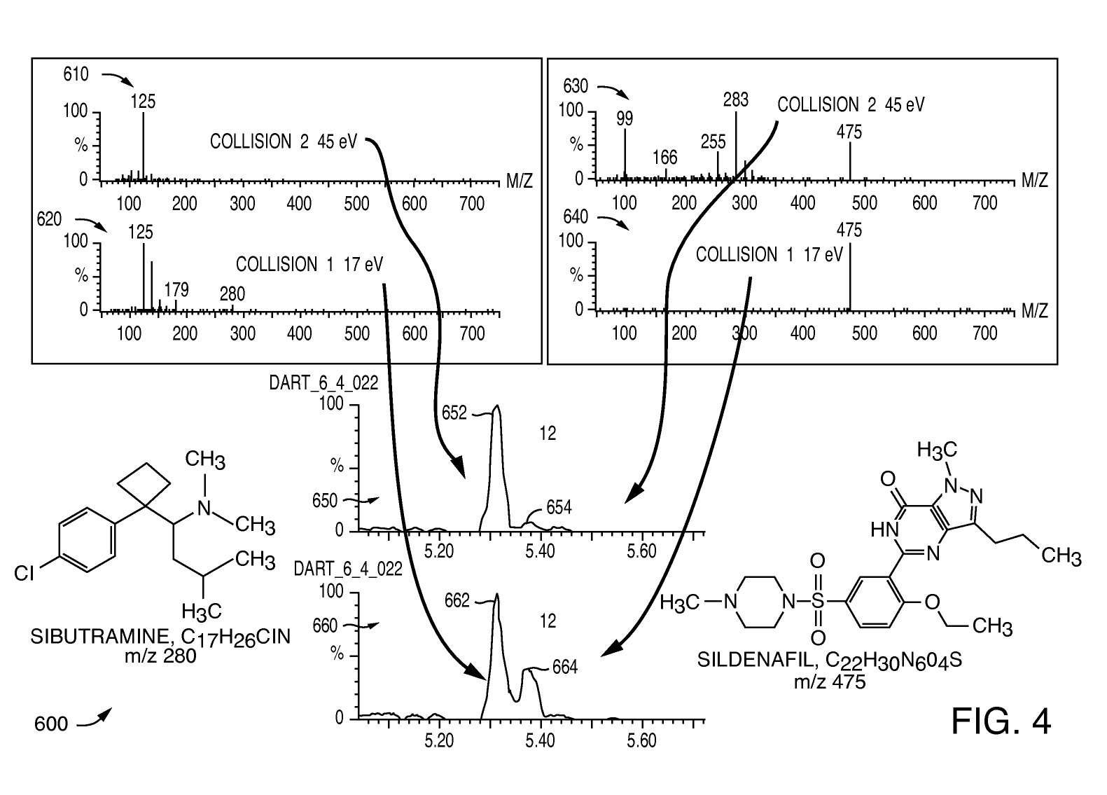

Referring to FIG. 4, shown is additional scan data in connection with portions of the scans from FIG. 2. Element 660 denotes a portion of the scan 420 enlarged to illustrate peaks or curves for sample 12 for the lower collision energy. Element 650 denotes a portion of the scan 430 enlarged for sample 12 for the higher collision energy. In connection with the illustrated data of 650 and 660, it should be noted that reproducible separation between peaks corresponding to different components of the sample 12 is visible.

Peaks 654 and 664 were observed and further data analysis performed for data selected as being included in the peak. The further analysis of the foregoing peak data is illustrated in 630 and 640. Element 630 represents the average intensity for the illustrated m/z values for the width of the peak 654 in connection with data acquired in scan 430 (high collision energy 45 eV). Element 640 represents the average intensity for the illustrated m/z values for the width of the peak 664 in connection with data acquired in scan 420 (low collision energy 17 eV). As can be seen, the fragmentation spectra of 630 and 640 match, respectively, the fragmentation spectra 530 and 540 of FIG. 2 for sildenafil. Thus, the signature fragmentation spectra for sildenafil (e.g., as illustrated by 530, 540, 630 and 640) is reproducible in connection with samples 1 and 12 and identifies that sample 12 contains sildenafil.

Peaks 652 and 662 were observed and further data analysis performed for data selected as being included in the peak. The further analysis of the foregoing peak data is illustrated in 610 and 620. Element 610 represents the average intensity for the illustrated m/z values for the width of the peak 652 in connection with data acquired in scan 430 (high collision energy 45 eV). Element 620 represents the average intensity for the illustrated m/z values for the width of the peak 662 in connection with data acquired in scan 420 (low collision energy 17 eV). As can be seen, the fragmentation spectra of 610 and 620 match, respectively, the fragmentation spectra 510 and 520 of FIG. 2 for sibutramine. Thus, the signature fragmentation spectra for sibutramine (e.g., as illustrated by 510, 520, 610 and 620) is reproducible in connection with samples 1 and 12 and identifies that sample 12 contains sibutramine. In this manner, for example, if sample 12 is an unknown sample or rather a sample whose component(s) are unknown and the fragmentation spectra 510, 520, 530 and 540 are known as signature fragments of sildenafil and sibutramine, then it may be determined through matching such fragment information that sildenafil and sibutramine are components of sample 12.

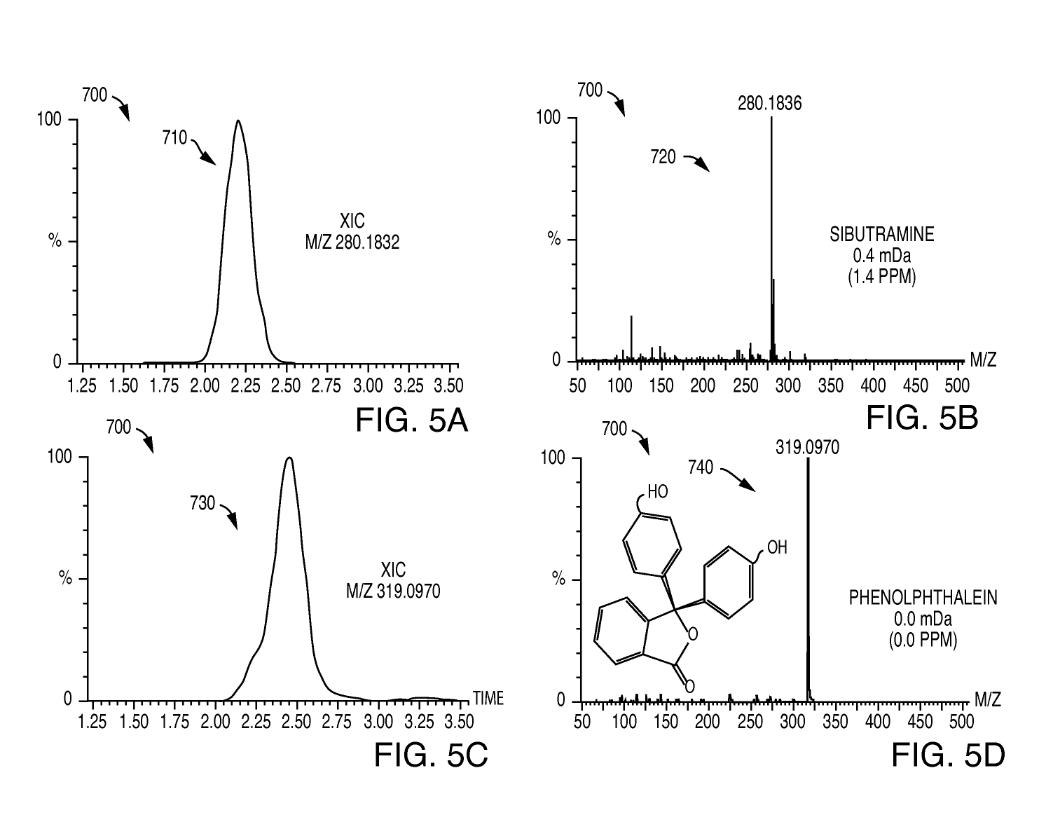

Referring to FIG. 5, shown is additional scan data in connection with sample 1. Element 710 illustrates data of an XIC or extracted ion chromatogram for m/z=280.1832 which approximates that of sibutramine. It should be noted that the peak of 710 may be detected using techniques such as described in the '263 and '327 patent applications. In 710 and 730, the x axis represents time and the y axis represents ion intensity in terms of relative percentage as noted above. In 710 and 730, the peak illustrated is denoted as 100% intensity level with other points of the curve being scaled relative to this intensity level. The XIC of 710 is obtained using data for sample 1 of the original survey scan data 410 obtained at different points in time for a single m/z=280.1832 for a detected peak. In 720 and 740, the x axis is m/z and the y axis denotes intensity in terms of relative percentage for the denoted peak as described above. Element 720 represents the average intensity of the different m/z's during the time corresponding to the peak width of the single peak in 710. The XIC of 730 is obtained using data for sample 1 of the original survey scan data 410 obtained at different points in time for a single m/z=319.0970 for a detected peak which approximates that of Phenolpthalein having a monoisotopic mass of 318.089209. Element 740 represents the average intensity of the different m/z's during the time corresponding to the peak width of the single peak in 730.

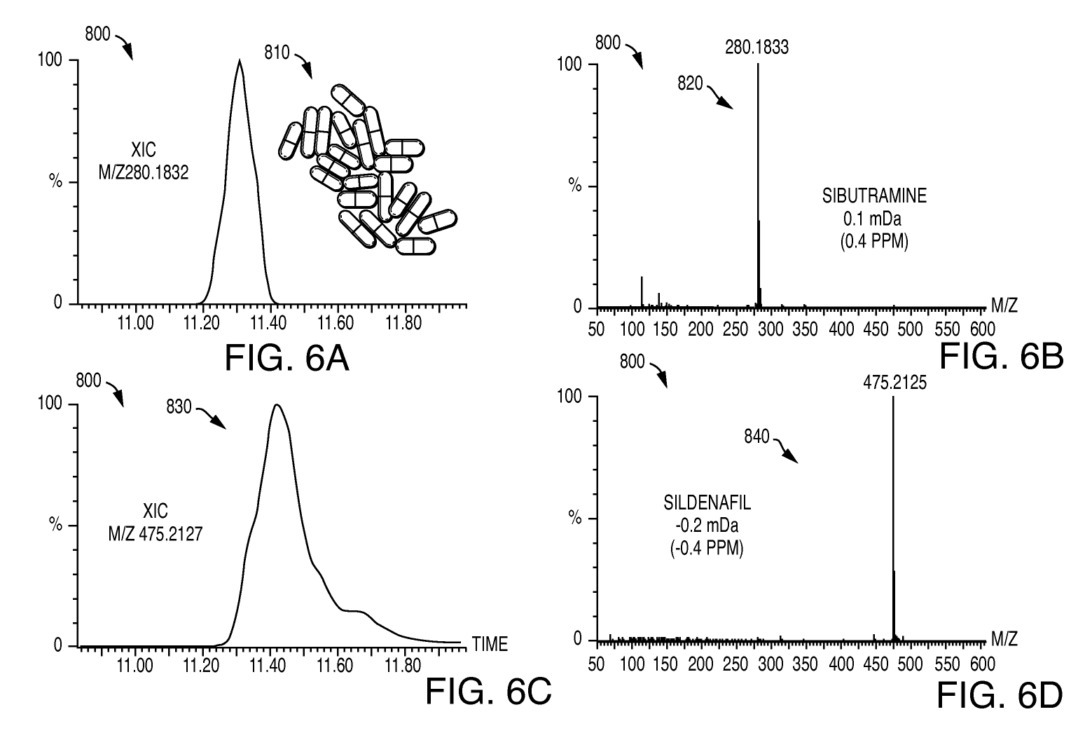

Referring to FIG. 6, shown is additional scan data in connection with sample 5. Element 810 illustrates data of an XIC or extracted ion chromatogram for m/z=280.1832 which approximates that of sibutramine. It should be noted that the peak of 810 may be detected using techniques such as described in the '263 and '327 patent applications. In 810 and 830, the x axis represents time and the y axis represents ion intensity in terms of relative percentage as noted above. In 810 and 830, the peak illustrated is denoted as 100% intensity level with other points of the curve being scaled relative to this intensity level. The XIC of 810 is obtained using data for sample 5 of the original survey scan data 410 obtained at different points in time for a single m/z=280.1832 for a detected peak. In 820 and 840, the x axis is m/z and the y axis denotes intensity in terms of relative percentage for the denoted peak as described above. Element 820 represents the average intensity of the different m/z's during the time corresponding to the peak width of the single peak in 810. The XIC of 830 is obtained using data for sample 3 of the original survey scan data 410 obtained at different points in time for a single m/z=475.2127 for a detected peak which approximates the monoisotopic mass of sildenafil. Element 840 represents the average intensity of the different m/z's during the time corresponding to the peak width of the single peak in 830.

Elements 810 and 830 show ion peaks that may be detected from XICs. In a manner similar to that as described above, if sample 5 contained unknown components and the data of 700 were known so that 710 was known as a signature for sibutramine, then one of the components of the sample 5 may be determined as sibutramine based on matching characteristics of 710 and 810.

The above-mentioned figures illustrate mass spectral data obtained as a result of performing an experiment repeated for 12 samples. As also described above, each sample was introduced into the ion source using a probe into an ion source and ions were generated using an atmospheric chemical ionization technique (without prior separation) using DART technology by IonSense™. As described herein, the probe may be used as the means by which the sample source (e.g., liquid or solid) is introduced into an ion source, such as an API (atmospheric pressure ionization) source used in connection with mass spectrometers such as the Waters Synapt HDMS™ mass spectrometer. More generally, the use of the probe in connection with performing API as described above may be characterized as used in connection with performing atmospheric pressure “surface” (rather than “solid” analysis) of a sample where the sample may be, for example, a solid, liquid, tissue or other material sample and the sample to be analyzed may be more generally introduced for analysis using any means having a surface.

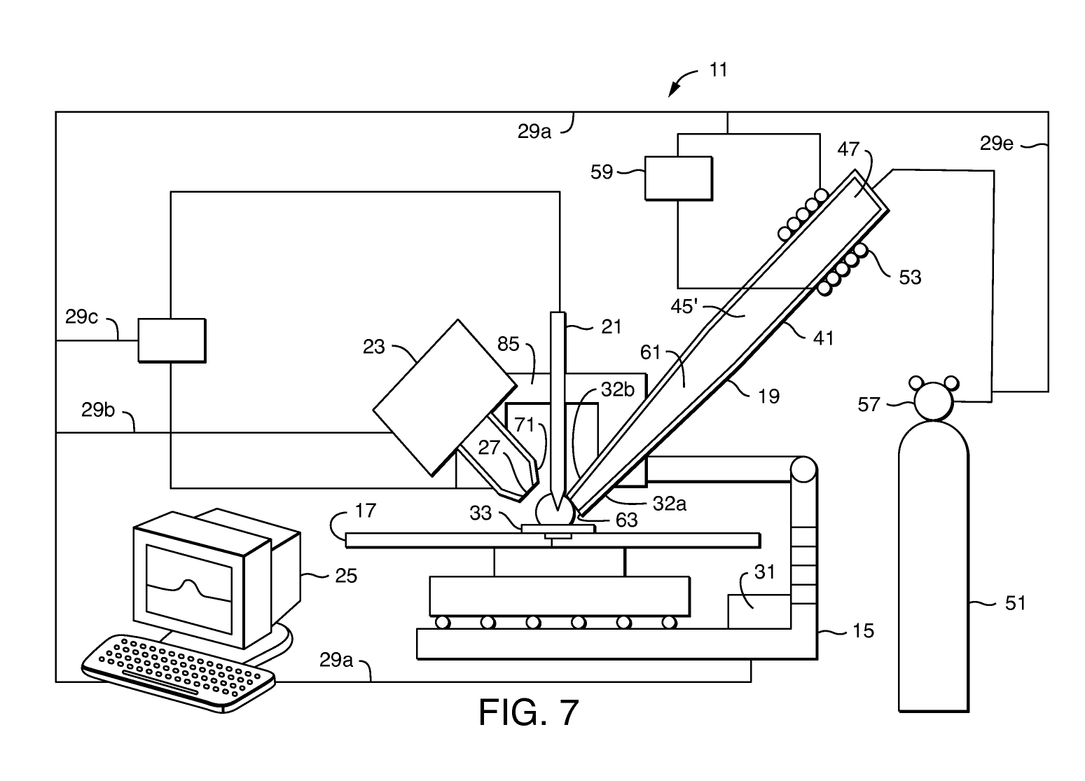

Referring to FIG. 7, shown is an example of an apparatus that may be used in connection with performing atmospheric pressure “surface” analysis in an embodiment in accordance with techniques herein. The apparatus of the example 11 is based on the apparatus as described in U.S. patent application Ser. No. 13/105,605, filed May 11, 2011, Attorney Docket No. W-634-01, DEVICES AND METHODS FOR ANALYZING SURFACES, (the '605 patent application) which is incorporated by reference herein. The apparatus or device 11 may be used to perform analysis of a sample having a sample surface. The device 11 may include the following major components: a frame element 15, sample holder 17, a jet element 19, an electrode 21, a charged particle analyzer 23 and computer means 25. The “computer means” 25 may refer to computer processing units (CPUs) which are internal to the device 11 or linked by signal communication means to external CPUs. The term includes personal computers, mainframe computers, servers, and handheld devices. As used herein, the term “signal communication” refers to wired together, or able to pass data or command instructions by wireless means such as radio, electro-magnetic transmissions and reception, infra red and other photo-communication devices. Computers, CPUs, and signal communication devices and the like are available from numerous venders. As depicted, the computer means 25 is in signal communication with the frame element 15, jet element 19, electrode 21 and charged particle analyzer 23 via signal communication device 29a through 29e.

The charged particle analyzer 23 has an ion or charged particle receiving orifice 27. A preferred charged-particle analyzer 23 comprises a mass spectrometer or an ion mobility analyzer. Such analyzers are well known and may comprise, by way of example, without limitation, quadrupole, time-of-flight, magnetic sector or ion trap mass spectrometers, preferably having a system of ion guides/and or traps to permit it to receive ions at atmospheric pressure. Charged particle analyzers 23 are well known in the art and available from several venders, including Waters Corporation, Milford, Mass., USA. The element 23 may be analogous to the element 204 as described in connection with FIG. 1.

The frame element 19 is affixed to the sample holder 17, electrode 21, jet element 19 and a charged particle analyzer 23. The frame element 19 has motor means 31 for moving the sample holder 17 with respect to the jet element 19, electrode 21 and charged particle analyzer 23. The motor means 31 is one or more electrically powered motors such as a stepper motor [not shown] mechanically linked through screws, gears and linkages [not shown] is conventional manner to move the sample holder 17 and the sample, generally designated by the numeral 33, placed thereon.

The position of the sample 33 held by the sample holder 17 with respect to the jet element 19, electrode 21 and ion receiving orifice 25 is controlled the by computer means 25. Computer means 25 is programmed to move the sample and relate the position of the sample and the area of the sample receiving a stream of gas to data from the charged particle analyzer 23 to generate a scan comprising a plurality of sample areas.

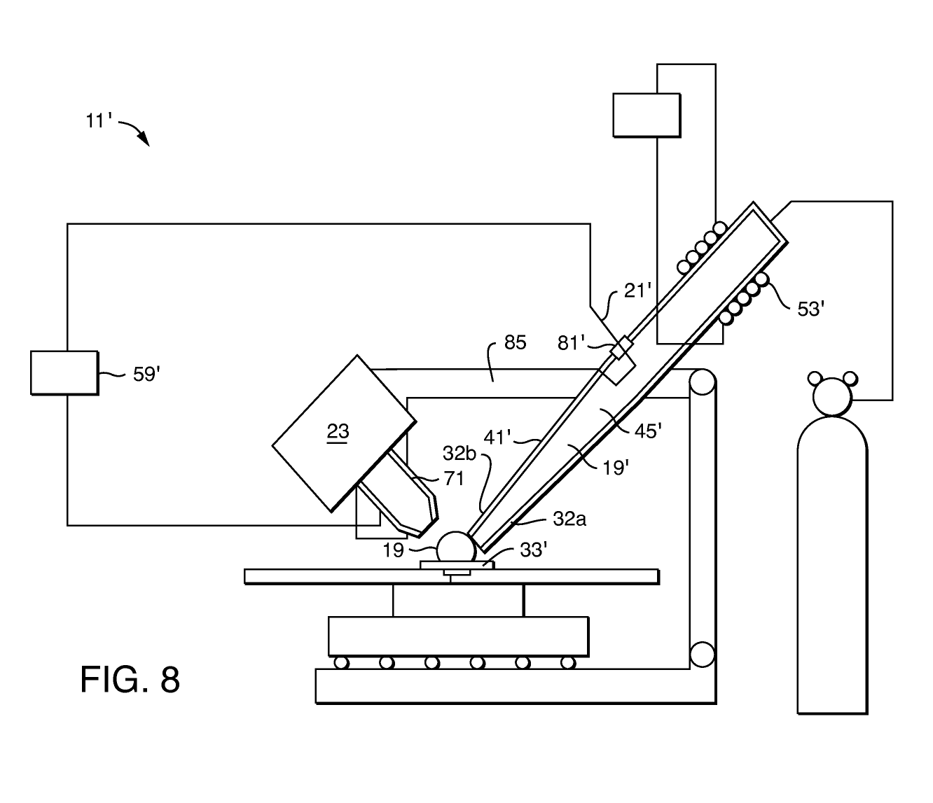

A preferred sample holder moves in at least two directions, for example about an x and y axis, and more preferably, three directions, for example about an x-y-z axis. A preferred sample holder permits rotation to allow the sample 33 to receive a stream of gas at different angles. Those skilled in the art will recognize that the sample holder 17 may take several forms. As depicted in FIGS. 7 and 8, the sample holder 17 is a simple platform for placing a sample having at least one sample surface. However, the sample holder may comprise sticky surfaces, clamps, holding vessels and the like [not shown].

The jet element 19 is for directing a jet of gas towards the sample 33 held by the sample holder 17. The jet element 19 produces a stream of gas focused on less than 2.0 mm² of the sample surface, and even more preferably, less than 1.0 mm². The jet element 19 has a conduit 41 having at least one wall 43 defining an interior conduit surface 45 defining a passage 47 for gas and an exterior surface 49. The conduit 41 is constructed and arranged to be placed in fluid communication with a gas source 51. Jet element 19 receives gas from a gas source 51 via a flow regulator 57 in signal communication with computer means 25. Preferred gases are inert, such as nitrogen, helium, argon, or neon. A trace reagent gas, for example water vapor or ammonia, may be added to assist formation of ions from the analyte molecules, as is sometimes done in prior atmospheric pressure ionization sources.

Jet element 19 has a gas heating (or cooling) element 53 for controlling the temperature of the gas flowing through passage 47. The gas heating (or cooling) element 53 is preferably selected from the group comprising peltier devices, electrical resistance elements, heated or cooling jackets and the like [not shown]. Electrical resistance elements include wire coils, electrical resistance tape and electrical resistance wires. The electrical resistance element 53, as shown in FIG. 7 is disposed on an exterior surface 49 of the jet element 19.

In the alternative, the electrical resistance element 53 is fixed in a position in the about the interior conduit surface 45 of the conduit 41. Suitable materials for the electrical resistance element 53 may comprise platinum, gold, or alloys such as Nichrome or Kanthal. Jet element 19 aerodynamically focuses gas on to a limited area of the surface of a sample 33. A preferred jet element 19 is a capillary having a electrical resistance element 53 in the form of a heating wire or tape wrapped about its exterior surface 49 which wire or tape is powered by a suitable power supply 59. The heating of the heating element 53 is controlled by computer means 25.

A preferred gas heating (or cooling) element 53 heats gas to a temperature between 20 and 700° C. The temperature may be selected by adjusting the power fed to the heater so that the maximum efficiency of desorption of the analyte is obtained, but will be limited by the possibility of thermal decomposition. The optimum temperature used will therefore be dependent on the nature of the analyte. In the case of analytes which are thermally unstable, it is possible to cool the substrate which comprises the surface 4 and use relatively low temperatures of the gas. Cooling of the surface may also be useful if it is desired to freeze a solution comprising analytes on the surface.

The conduit 41 has an internally tapered portion 61 proximal to an exit orifice 63. This geometry confines the flow of gas to a limited, defined area of the sample surface. One or more analytes [not shown] may be deposited on the sample surface or the surface itself may be the object of the analysis.

Jet element 19 is preferably made of a material having a low thermal conductivity, for example fused silica or ceramic. A preferred jet element 19 is manufactured from a length of tubing drawn down to form an internally tapered portion 61 and an exit orifice 63 of between 1 and 10 micron in diameter. The size of the area of the sample 33 from which the analyte may be desorbed is determined by the diameter of exit orifice 63, the distance between the exit orifice 63 and the surface of the sample 33, and the nature of the tapered portion 61. An exit orifice 63 with a small diameter will direct gas on a smaller area of the sample and therefore will have greater spatial resolution than exit orifices 63 with larger diameters.

Gas emerging from the exit orifice 63 diverges; thus, the shorter the distance between the exit orifice 63 and the surface of sample 33, the smaller will be the r area to which the gas flow is directed and the greater will be the spatial resolution. A preferred diameter of exit orifice 63 is between 1 and 10 microns and the distance between the exit orifice 63 and the surface of the sample is between 0.1 and 1.0 mm. The area of the sample from which ions or charged particles are generated is less than 1 mm², and preferably, the use of the smaller diameters and distances limits the area to less than 0.1 mm².

The electrode means 21 is for generating ions from at least one of the group comprising gas molecules forming the stream, gas molecules leaving the sample surface, and molecules and particles from the sample surface to form one or more sample ions and/or charged sample particles. The electrode means 21 is affixed to at least one of the frame element 15 as shown in FIG. 7, and jet element 19, such as in FIG. 8. Ions and charged particles formed from the sample are received in the receiving ion orifice 27 of the charged particle analyzer 23.

A preferred electrode means 21 is a corona discharge electrode. The corona discharge electrode can be affixed to or integral with the jet element 19 as depicted in FIG. 8 or as a separate element as depicted in FIG. 7.

With reference to FIG. 7, electrode means 21 is a sharply pointed metallic rod affixed to the frame element 19, disposed adjacent to the exit orifice 63 of the jet element 19 and the sample 33. This electrode means 21 is used to generate a corona discharge adjacent to the sample 33. A potential difference is maintained between the electrode means 21 and a counter electrode 71 which in the FIG. 7 embodiment comprises the entrance of a charged-particle analyzer 23. In the alternative, the counter electrode may comprise conductive portions of the sample holder 17, a further metallic rod [not shown] or portions of an enclosure [not shown]. An electrode power supply 23 in electrical communication with counter electrode 71 electrode means 21 creates an electrical potential between electrodes.

The electrode means 21 results in the generation of charged particles from the desorbed analyte molecules in the discharge by an atmospheric pressure ionization mechanism. These charged particles are characteristic of the analyte present on or in the area to which the gas is directed on the sample 33. The chemical mechanism by which the charged particles are formed is thought to be similar to that present in conventional atmospheric pressure ionization sources used in mass spectrometry. It should be noted that these charged particles are formed in the gas phase from neutral molecules of the analyte which have been desorbed by the action of thermally excited neutral molecules of hot gas from the jet element 19.

A thermocouple or other suitable temperature sensor/device may be located near the surface of the sample. For example, an embodiment may affix a thermocouple near an end of the jet element 19 such as at location 32a or 32b on an exterior surface of an outer wall 41 of the jet element 19. Although not illustrated, the temperature monitored by the thermocouple may be communicated to a computer, such as computer means 25 as part of a feedback mechanism whereby the computer may then issue commands to control and suitable adjust the heating and/or cooling element 53 based on the observed temperature using the thermocouple and the desired temperature such as may be included in a thermal gradient. In this manner, the temperature near the sample surface may be monitored to control the temperature such as of the temperature gradient used in connection with techniques herein.

Referring to FIG. 8, an alternative electrode means 21′ is disposed inside the jet element 19′, downstream of the gas heater 53′. The apparatus or device 11′ includes components similar that as described above in connection with FIG. 7 with a difference as to the location of the electrode means. A power supply 59′ is connected between the electrode means 21′ and the entrance electrode 71 of the charged-particle analyzer 23. However, alternative counter electrodes can be used, as described above for in connection with FIG. 7. Electrode means 21′ produces a corona discharge adjacent to the exit orifice of the jet element 19′ over a limited area of the surface of sample 33′. The corona discharge generated in this way may be of smaller extent than that produced in connection with FIG. 7, which may increase the efficiency of the generation of charged particles and assist in improving the spatial resolution of the device 11′. The electrode means 21′ may be a sharply pointed rod or wire, bent at right-angles and inserted through a hole 81′ in the wall 41′. It may be held in place by a sealant or may be fused into the wall, for example by means of a glass-metal or quartz-metal graded seal.

Returning to FIG. 7, the frame element 15 maintains the electrode means 21, the ion receiving orifice 27 and the jet element 19 in a constant position with respect to each other. A preferred frame element 15, in this regard, has a head piece 85 in which the ion receiving orifice 27, jet element 19 and electrode means 21 are held. The ion receiving orifice 27, jet element 19 and electrode means 21 are preferably maintained approximately 0.01 to 0.3 cm from the surface of the sample. Preferably, the ion receiving orifice 27, jet element 19 and electrode means 21 are maintained approximately 0.2 to 1.5 cm from each other.

With reference to FIG. 8, the electrode means 21 is held within the jet element 19′ such that the head piece 85 maintains and is affixed to the jet element 19′ and charge particle analyzer 23.

With reference again to FIG. 7, the sample holder 17 moves with respect to the jet element 19 and ion receiving orifice 27 to allow a first area of a surface of a sample 33 to receive a stream of gas and produce one or more ions during a first time period and at least a second area of a surface of the sample to receive a jet and produce one or more ions during a second time period. The data relating to the various times and areas form a scan of the sample surface. The frame element 15 maintains the position of the surface of the sample 33 to be analyzed, the jet element 19 and ion receiving orifice 27 in a close relationship, preferably, within 2.0 mm² of each other. Computer means 25 is in signal communication with the frame element 15, the jet element 19 and the charged particle analyzer 23. The computer means 25 can infer the position of the sample 33 from the position of the frame element 15 with respect to the sample holder 17, ion receiving orifice 27, jet element 19 and electrode means 21 or 21′.

The computer means 25 receiving data indicative of the sample from the charged particle analyzer 23, relates the data to the first area or the at least second area as the sample holder 17 assumes different positions to produce a scan or image of the sample surface.

In connection with analyzing a single sample having a sample surface, the sample 33 may be held in the sample holder 17 to expose at least one sample surface. Next, a jet or stream of heated gas is directed on the surface of the sample 33 to form a first area having an area not greater than 2.0 mm². Next, ions are created from at least one of the heated gas directed on the surface, a heated gas leaving the surface and one or more ions from molecules from the sample 33, by corona discharge by electrode means 21. Next, these ions are received in an opening 27 of a charged particle analyzer 23 to form an ion analysis of the first area. The sample holder 17 is moved with respect to the jet of gas from jet element 19 and the ion receiving orifice 27 of the charged particle analyzer 23 to form at least one second area of the sample. The first area data and the at least one second area data are assembled by computer means 25 to produce a scan of the sample surface.

Thus, using the above-mentioned apparatus, a single sample on a surface may be analyzed during a time period using a thermal gradient or ramp. The sample surface being analyzed may be moved to repeat the experiment on a new surface location such as for another sample. Generally, the analysis may proceed from surface sample area to subsequent surface sample area by appropriately adjusting or moving the sample holder of the device containing the sample. A sample surface area for a first sample may be processed using techniques herein in portions as described above whereby a first portion of the sample area may be analyzed using the thermal ramp and then a second different portion of the sample area may be analyzed be repeating using the same thermal ramp. The multiple sample area portions of the same sample may be assembled by computer means 25 to produce a scan of the sample surface for the first sample. Processing may then proceed to repeat the experiment for a second different sample in a manner similar to that as described for the first sample.

Thus, a controlled thermal cycle or gradient may be used to provide a discrete peak shape for components of complex mixtures by desorption temperature. Such processing and analysis provides for differentiating thermally derived components in a sample by thermal gradient separation since chemically different components of the sample volatilize at different desorption temperatures. Gradually increasing or decreasing temperature/heat to a selected spot on the surface in time, techniques herein allow for using a thermal gradient to desorb each component in the time sequence at its characteristic desorption temperature. Each component presents its mass spectral features at a point in time corresponding to the thermal desorption temperature of that component.

Additionally, the thermal gradient profile can be optimized such as for the particular sample and its components. A simple profile may be, for example, by application of constant power to the thermal source. The profile may be an oscillating profile (e.g., where the thermal gradient changes or may be tuned for different samples) as different components may respond differently to different temperature gradients.

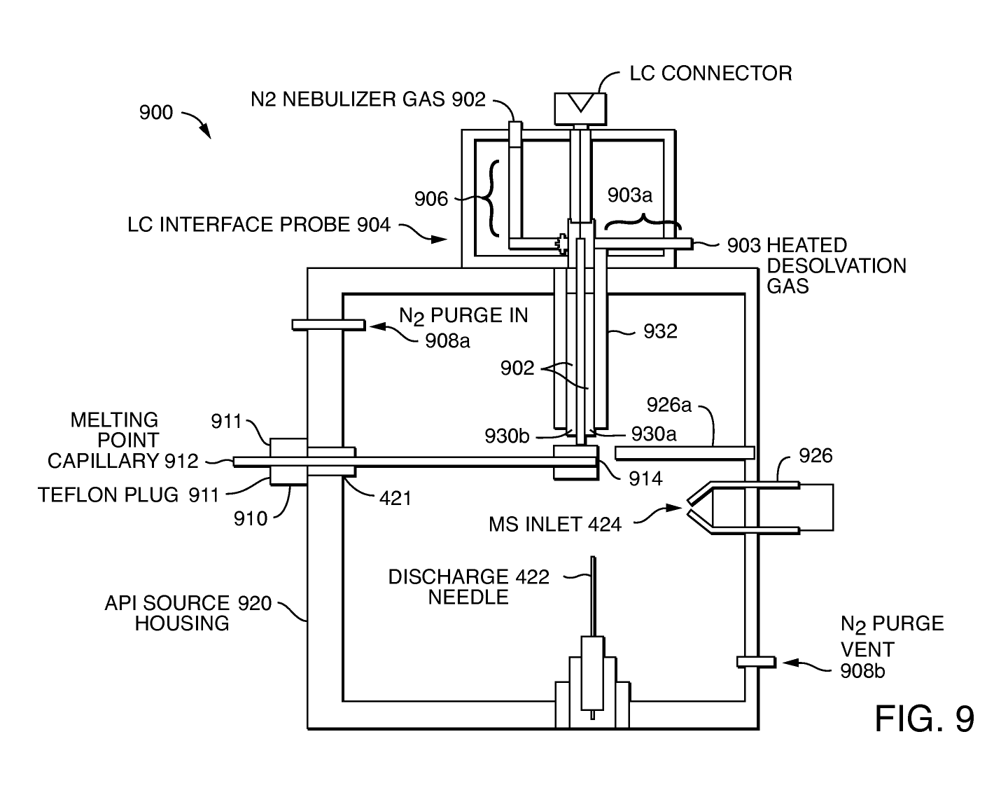

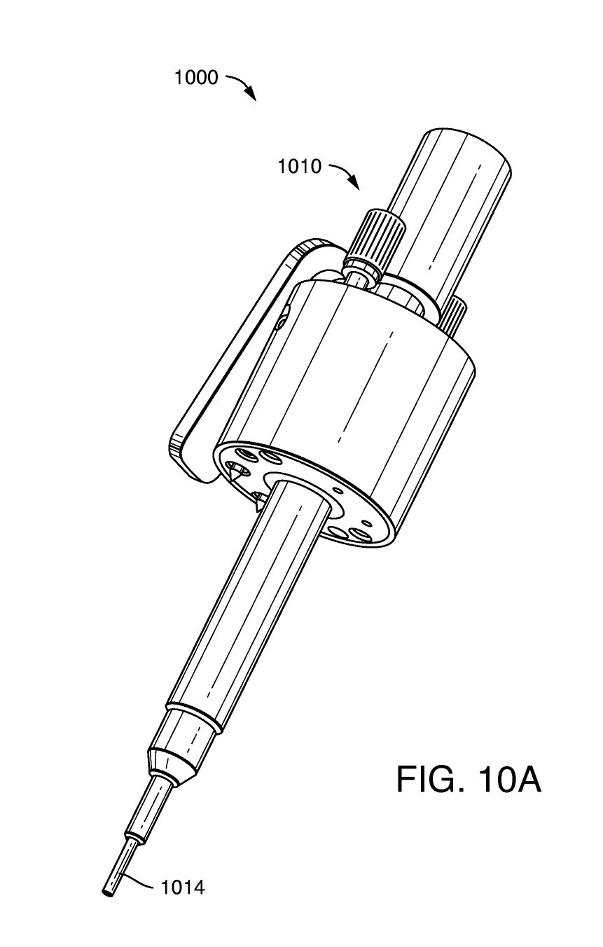

Referring to FIG. 9, shown is another example of a desorption and ionization component or environment as may be used in an embodiment in connection with techniques herein. Element 900 illustrates an exemplary environment that may be used for performing desorption and ionization of sample components using techniques herein whereby the sample is introduced into the environment by means of probe assembly 910. The example 900 includes an atmospheric pressure ionization (API) source housing 920. The probe assembly 910 is inserted into the housing 920 through an opening or port 921 in a wall of the housing 920. The probe assembly 910 may include a removable melting point capillary 912 inserted as an inner portion into an outer surrounding portion 911 of the probe assembly. The probe assembly 910 may be designed so that when 910 is inserted into housing 920, inner portion 911 including the capillary with the sample may be removable while the remaining outer or surrounding portion 911 remains within the opening 921 to allow for rapid sample introduction without removal of the complete probe assembly. Element 914 denotes a sample area located at one end of the capillary 912. A sample, such as a solid or liquid or other material, may be applied as by coating the outer capillary surface in the region 914 exposed in the API source housing. In one embodiment, a heated gas may flow through the conduit 932 in the path/layer denoted for the nebulizer gas 902 or the path/layer for the heated desolvation gas 903 (e.g., 903 is a layer surrounding the layer of the nebulizer gas 902 in the conduit 932). In a manner similar to that as described elsewhere herein (such as in connection with FIG. 7), the heated gas flows through 923 entering into the housing 920 near sample region 914. The heated gas causes the components comprising the sample located on the surface of 914 to desorb and then such desorbed components may be further ionized. The generated ions then enter into the MS inlet 924. In this example, APCI may be the ionization technique using the discharge needle or first electrode 922 and counter electrode 926. As in connection with FIG. 7, when the needle or first electrode 922 is energized with a high voltage source, an electric discharge is generated between 922 and 926 in a region or area near 914. The counter electrode may also be located elsewhere within the housing 920 such as attached to an inner wall of the housing 920 as denoted by 926a. In an embodiment in which APPI is used as the ionization technique, needle 922 may be replaced with a photolamp capable of ionizing radiation.

If the heated gas flows through path/layer 902, element 906 denotes an area where a heating device used to heat the gas may be located. Elements 930a, 930b may denote locations where a thermocouple or other temperature sensor device may be located at the end of conduit 932 (through which the heated gas enters into the housing 920). The temperature sensor device and heating device in area 906 may be in communication with a computer and electronic control means (not illustrated) of a feedback system used to control the temperature of the heated gas 902 by adjusting the heat applied in area 406 based on the desired temperature at various points in time for a temperature gradient. As described elsewhere herein, the temperature sensor device may monitor the temperature at the end of the conduit 932 near the sample region 914. If the heated gas flows through layer 903 (rather than 902), element 903a denotes an area where the heating device used to heat the gas may alternatively be located (rather than in area 906). Elements 908a, 908b denote venting to allow the heated gas to flow out of the housing 920. It should be noted that an embodiment may perform techniques herein using a heated gas through one or both of the above-mentioned paths/layers (e.g., 902 and/or 903).

When the probe assembly 910 is used to introduce a sample for analysis rather than introduce samples from a connected LC, the gas may be heated to a desired temperature for use in connection with techniques herein as noted above. Alternatively, when the sample is introduced from a connected LC, the port or opening 921 may be sealed using any suitable means (e.g., using a plug) rather than have the probe assembly 910 inserted therein.

Using the techniques herein with the example environment of 900 allows direct analysis of samples using an atmospheric pressure ionization (API) source found on Liquid Chromatography Mass Spectrometry (LCMS) instruments. The probe permits fast analysis of solid, liquid, tissue, or material (e.g. polymer) samples. As described elsewhere herein, the heated gas causes components of the sample to desorb where the desorbed components are then ionized such as by APCI or APPI. One embodiment of the probe 910 may be the Waters Atmospheric Solids Analysis Probe (ASAP) by Waters Corporation which is readily fitted to a standard API source by replacing either the ESI (electro spray ionization) or APCI probe assembly as may be used with LC/MS analysis. A corona discharge pin or needle such as 922 also requires fitting. The close proximity of the sample, when loaded onto a capillary 912, to the point of ionization and the MS inlet, improves sensitivity while also ensuring safety due to the enclosed source housing 920.

Additional details, embodiments and variations of the ASAP probe and environment that may be used for desorption and ionization with respect to a sample being analyzed in an embodiment in accordance with techniques herein may found, for example, in U.S. Pat. No. 7,977,629, issued Jul. 12, 2011, ATMOSPHERIC PRESSURE ION SOURCE PROBE FOR A MASS SPECTROMETER, McEwen et al., which is hereby incorporated by reference.

It should be noted that the gas used in connection with heating the sample in any of the above-mentioned embodiments may be, for example, nitrogen or helium heated by convection or any suitable means.

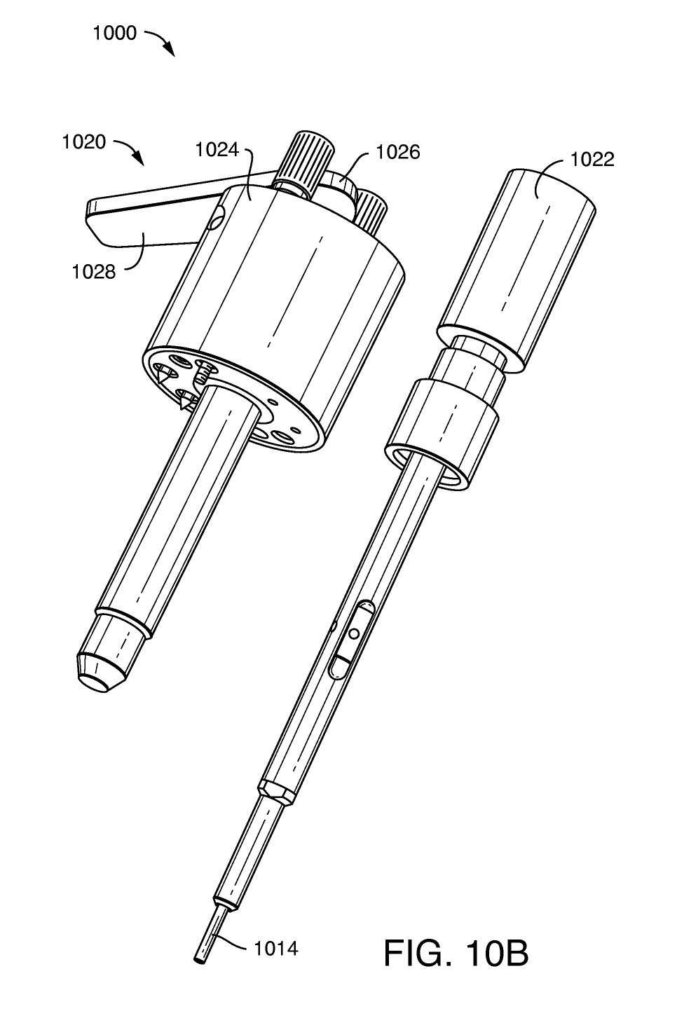

Referring to FIG. 10, shown is an example 1000 illustrating an embodiment of the probe assembly 910 that may be used in connection with techniques herein. The example 1000 illustrates the ASAP probe by Waters Corporation as noted above. As illustrated in 1020, this embodiment of the probe assembly has been designed in two parts—an inner portion 1022 (including the capillary 1014 with the sample thereon) and an outer portion 1024. Element 1026 may denote a through hole in a center portion of 1024. Inner portion 1022 is inserted into 1026 of the outer portion 1024 when assembled as illustrated in 1010. In this manner, inner portion 1022 may be removed from the probe assembly leaving the outer portion 1024 in place when the probe assembly is fitted for use in the housing 920 of FIG. 8. The melting point capillary of 1022 is held in place by a spring loaded lever mechanism. When the lever 1028 is depressed (as in 1010), the capillary drops out and a new one can be readily inserted. The capillary may be made of glass, silica or other suitable material.

Additionally, and more generally, the components of the various embodiments described herein may be made of any suitable material some of which are described herein.

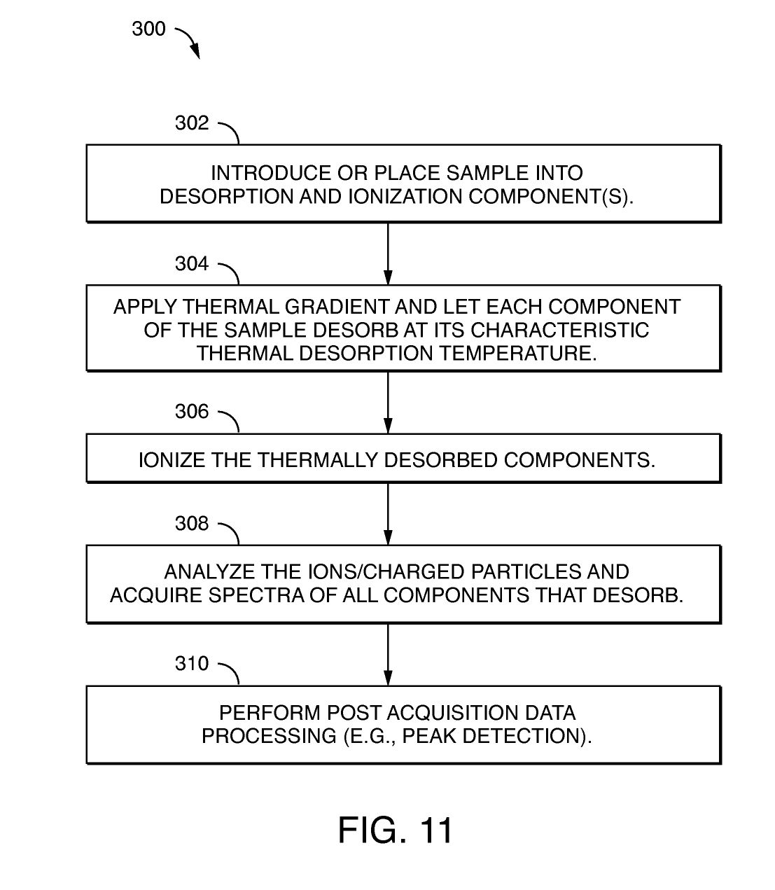

Referring to FIG. 11, shown is a flowchart 300 summarizing processing steps as may be performed in an embodiment in accordance with techniques herein. The processing steps of 300 as illustrated are performed with respect to a single sample. However, as described elsewhere herein and as will be appreciated by those skilled in the art, the processing steps of 300 may be repeated for multiple samples. At step 302, the sample to be analyzed is introduced or placed into the desorption and ionization component or environment. As described herein, the desorption and ionization environment may be an ion source of a mass spectrometer. Exemplary embodiments of a desorption and ionization environment are described herein. The ion source may perform desorption and ionization of components of the sample using an atmospheric pressure technique such as atmospheric pressure chemical ionization (APCI) or atmospheric pressure photoionization (APPI). The sample may be introduced or placed in this component in any manner suitable for the particular component and environment performing the desorption and ionization of sample components. For example, the sample may generally be placed on a surface and introduced into the desorption and ionization component or environment. In one embodiment, a probe such as an ASAP probe described herein may be used as the means to introduce the sample for desorption and ionization. In another embodiment described herein, the sample may be placed on a surface of sample holder. The sample holder may include one sample or may include multiple samples for use with processing in connection with techniques herein. As described herein, in step 304, a thermal gradient may be applied with respect to the temperature of the hot gas causing components of the sample to thereby desorb at various different desorption temperatures at different points in time. In this manner, each component of the sample desorbs at its characteristic thermal desorption temperature. In step 306, the thermally desorbed components of the sample are ionized. The ions or charged particles produced by step 306 may then be subject to further analysis and processing in step 308. As described elsewhere herein, the ions or charged particles produced by step 306 may be introduced into an MS for mass analysis. As a variation, the ions or charged particles produced by step 306 may be analyzed by performing IMS-MS. As a result of the analysis in step 308, spectral data is acquired for all components of the sample that desorb and ionize. In step 310, the acquired spectra may be further processed in post acquisition data processing.

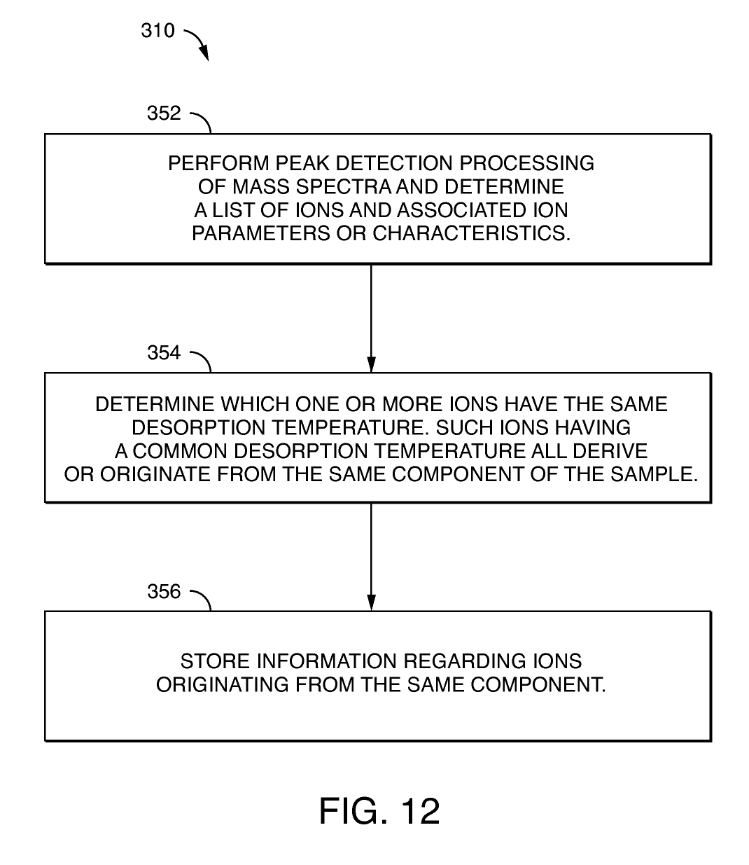

Referring to FIG. 12, shown is a flowchart of processing steps as may be performed in an embodiment in accordance with techniques herein as part of processing for step 310 of FIG. 11. The post acquisition data processing of step 310 may include performing peak detection processing as denoted by step 352. Peak detection processing of the mass spectra may be performed to determine a list of ions and associated ion parameters or characteristics. As described herein, peak detection processing and determining such a list of ions may be performed, for example, using techniques described in the '327 patent application. If step 308 includes performing MS without IMS, the generated mass spectral data may include information for m/z and time/desorption temperature separation dimensions and, thus, peak detection processing of step 352 may include determining peaks or apexes of ion intensity or abundance for the foregoing two separation dimensions. If step 308 includes performing IMS-MS, the generated mass spectral data may include information for an IM dimension in addition to m/z (MS) and time/desorption temperature separation dimensions. In this case, peak detection processing of step 352 may include determining peaks or apexes of ion intensity or abundance based on the foregoing three separation dimensions.

As described in the '327 patent application, mass spectral data which is analyzed for peaks may include data dimensions of retention time and m/z. Each detected ion intensity peak may denote a detected ion having parameters or characteristics including an ion intensity or abundance (as denoted by the peak), an m/z, and an associated point in time. In connection with techniques herein, the point in time at which the peak occurs is associated with a desorption temperature for that detected ion rather than a retention time as in the '327 patent application. If the processing of step 308 included performing IM in addition to MS analysis to acquire the analyzed spectra, then the above-mentioned ion parameters or characteristics may also include an ion mobility or drift time. Thus, an output of step 352 may be the list of ions and associated ion characteristics or parameters. In step 354, processing may be performed to determine which one or more ions have the same desorption temperature. Such ions having a common desorption temperature all derive or originate from the same component in the sample. In step 356, the information regarding the particular one or more ions originating from the same component may be stored, such as in a database, file, or other suitable data container. The information regarding the ions from the same component may be used in a variety of different ways. For example, consider a first case where the components of the sample are known. In this case, a first set of information regarding ions originating from the same first component may be stored as in step 356 and used as characteristic information identifying the ions for that component. The first set of information may be used at a later point in time to assist in identification of components in an unknown sample. For example, the unknown sample may be analyzed in a manner as described herein in FIG. 11 to obtain mass spectra. The mass spectral data may be processed as described in steps 352 and 354 of FIG. 12 to obtain a second set of information. The second set of information for the unknown sample may be compared to the previously obtained first set of information. For example, the ions and associated ion characteristics for the first component of the first set may be compared to the second set of information to determine whether the second set of information includes ions and ion characteristics that match those for the first component in the first set. If such comparison determines a match between ions and ion characteristics of the first set and the second set, then it may be determined that the matching ions of the unknown sample originate from the first component. The foregoing is similar to the processing performed in connection with identification of proteins and other molecules as may be included in a sample whereby the known sample and its known components may be used to determine a list of ions and associated ion parameters used as a fingerprint or map. Such fingerprint or map may be characterized as a profile including ion information for each component of the sample. In this manner, subsequently matching ion information obtained for an unknown sample to the profile may be used to determine or identify component(s) comprising the unknown sample. In connection with techniques herein, a match may be determined between two corresponding ions having the same or sufficiently similar (e.g., within a specified tolerance or threshold) values for ion parameters of the different dimensions such as m/z and desorption temperature. The required degree of correspondence between ions and ion characteristics for determining a “match” may vary. Furthermore, the required degree of correspondence may also vary when determining a “match” between first ions of a known component and second ions for the unknown sample in order to determine that the unknown sample includes the first component. For example, an embodiment may specify criteria in order to determine that the unknown sample is identified as including the known component. Such criteria may, for example, require that a particular number of one or more ions (e.g., at least two ions) must match between the first ions and the second ions in order to determine that the unknown component is the first component, may require that one or more particular ions must be included in both the first ions and the second ions in order to determine that the unknown component is the known component, and the like. Such criteria may specify a minimum number of matching ions in terms of requiring that a number of matching precursor or parent ions be found in ion information of the known and unknown sample, requiring a number of matching precursor or parent ions and associated product ions be found in ion information of the known and unknown sample, requiring a number of matching product ions be found in ion information of the known and unknown sample, and the like.

Performing such matching may be used alone or in connection with other techniques in connection with identification of particular component(s) comprising an unknown sample. The ion intensity or abundance parameter may be used in connection with quantification of ions and components. The foregoing and other uses may include any suitable application of acquired information such as described, for example, in the '327 patent application.

It should be noted that different suitable methods may be used with a system as described herein to obtain ion information such as for precursor and product ions in connection with mass spectrometry for an analyzed sample. Such methods provide effectively simultaneous mass analysis of both precursor and product ions. For example, a portion of a precursor ion may be fragmented to form product ions, and the precursor and product ions are substantially simultaneously analyzed, either at the same time or, for example, in rapid succession. One approach to such alternating, effectively simultaneous analysis, is described in U.S. Pat. No. 6,717,130 to Bateman, et al. (“Bateman”), which is incorporated herein by reference and describes application of an alternating voltage to a collision cell of an MS module to regulate fragmentation. Thus, depending on the experiment performed and operation of the MS (e.g., such as represented by element 204 of the example 200) an embodiment may use the techniques described in the Bateman '130 patent or other suitable technique which may utilize desorption temperature/time alignment observations to support the determination of which product ion(s) are derived from a particular precursor where the product ions are associated with their precursor ion in response to matching retention-time values.

Analysis of the mass spectra permits measurement of a desorption temperature/time value for both the precursor ion and its associated product or fragment ions. Moreover, for example, peak shape, width, and/or desorption temperature (corresponding to a point in time) of the peaks associated with precursor ions and with product ions may be compared to determine which product ions are associated with a particular precursor ion. The product ions are associated with their precursor ion in response to matching time/desorption temperature values and/or other characteristics such as peak profile or shape as described elsewhere herein. Furthermore and more generally, ions (precursors and fragments) derived from a common originating molecule may have a common desorption temperature and/or other similar characteristics.

In a TG/MS experiment as mentioned above, an ion can be described and/or referred to by its desorption temperature, mass-to-charge ratio or mass, charge state, and intensity. An originating molecule can give rise to multiple ions derived from the originating molecule where each such ion is either a precursor or a fragment. These fragments arise from processes that break up the originating molecule. These processes can occur in the ionization source or in a collision cell of the MS. Because fragment ions derive from a common desorbed originating component, they have the same desorption temperature and peak profile as the originating molecule. The desorption temperature and peak shapes of ions that derive from a common component are the same because the time of ion formation, fragmentation, and ion detection is generally much shorter than the peak width of the originating component.

With respect to ions that are generated from collision-induced disassociation of intact precursor ions, the fragment or product ions are associated with their parent precursor ion. In connection with one technique using the MS, a single precursor ion may be selected for fragmentation, such as by the first mass analysis stage or quadrupole in a triple quadrupole and the selected precursor ion may be subsequently fragmented. Alternatively, more than one such precursor ion may be selected for subsequent fragmentation.

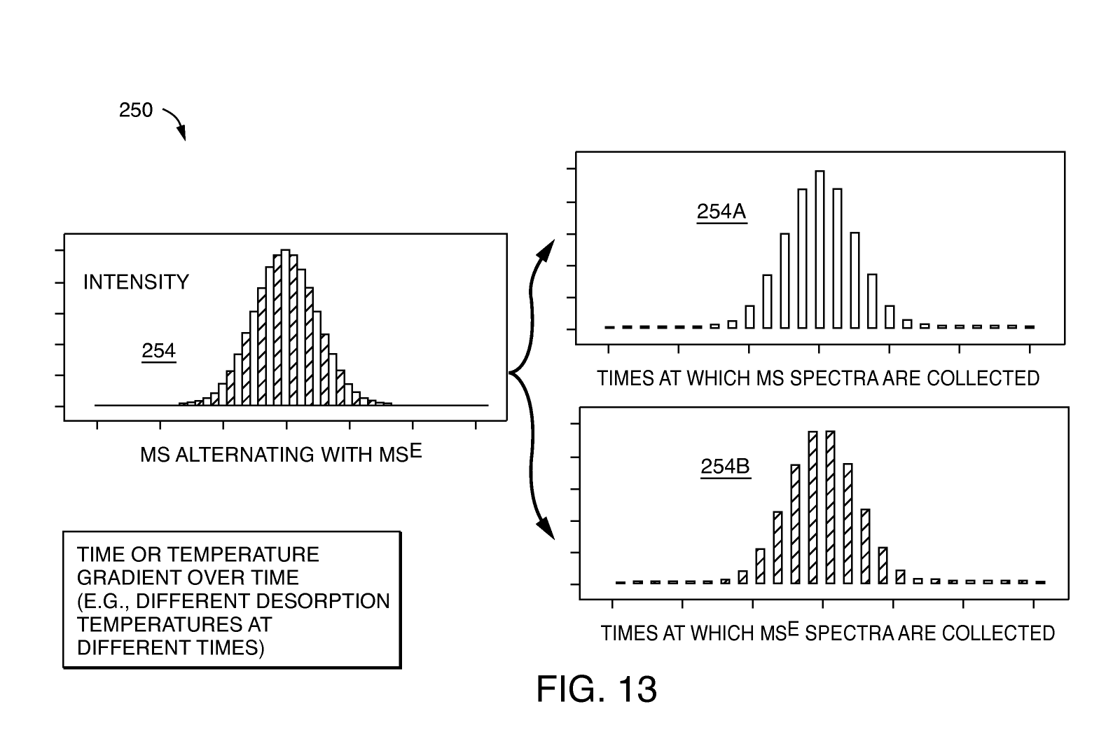

FIG. 13 shows three related graphs that illustrate the collection of mass spectra during a period of time that covers an peak of a precursor, according to one embodiment of the invention. A first graph 254 illustrates the alternating collection over time of low-energy spectra (i.e., spectra from unfragmented precursors, labeled “MS”) and elevated-energy spectra (i.e., spectra from fragmented precursors, that is, product ions, labeled “MS^{E}”.) Second and third graphs 254A, 254B respectively illustrate the MS and MS^{E} spectral collection times and the reconstruction of the desorption temperature peak associated with the precursor as may be generated using the alternating scanning technique described in the Bateman '130 patent.

The reconstructed peak represents the peak profile of a single precursor. The horizontal axis corresponds to time/desorption temperature of the peak profile. The vertical axis corresponds to arbitrary units of intensity associated with the time-varying concentration of the precursor as it is desorbed and then ionized.

A precursor thus produces ions in both low- and elevated-energy modes. The ions produced in the low-energy mode are primarily those of the precursor ions in possibly different isotopic and charge states. In elevated-energy mode, the ions are primarily different isotopes and charge states of the fragment, or product, ions of those precursors. High-energy mode can also be referred to as elevated-energy mode.

In the graph 254, the alternating white and black bars thus represent the times at which spectra are collected with low and high (or elevated)-energy voltages of the peak. The low-energy (LE) graph 254A depicts the times at which a low-energy voltage is applied in the collision cell 218, resulting in low-energy spectra. The high or elevated energy (EE) graph 254B depicts the times at which an elevated-energy voltage is applied in the collision cell 218, resulting in elevated-energy spectra.

In connection with techniques described herein, an embodiment may determine masses of particular precursors of interest using a variety of different techniques. For example, in one embodiment utilizing the Bateman techniques as described elsewhere herein, the low energy (LE) cycle or mode may be used to generate spectra containing ions primarily from unfragmented precursors while the elevated-energy (EE) spectra contain ions primarily from fragmented precursors or product ions.

As mentioned elsewhere, the resulting LE and EE scan data produced as a result of sample analysis may be used to identify compounds or components of interest in the sample such as by comparing precursor and fragment information determined for a sample to information in a database regarding known compounds as identified by their associated precursor and fragment information. Such identification may be performed using any suitable technique.

Thus, an embodiment in accordance with techniques herein may use the above-mentioned hi-lo technique such as illustrated in FIG. 13.

It should also be noted that frequency of time sampling is important. As with LC/MS, spectra obtained in connection with techniques herein may be acquired at a uniform rate suitable so allow for the ion intensity or response vs. time (e.g., different desorption temperature being associated with different points in time) differentiation for each component of the sample. Such an acquisition method may then produce a response signal that is indistinguishable from an LC/MS type of analysis where each peak appears at a retention time and has an m/z. Spectra need to be sufficiently sampled at a high enough rate to collect at least 5 spectra over the full width half height maximum (FWHM) peak width. Peak width may depend on various factors such as, for example, diffusion band, band spreading and loading effects. Without knowledge of the peak width or spatial spreading of a given component ahead of time, high frequency sampling (e.g., 20 spectra per peak) is needed.

Uniform sampling rates for such a system permits acquisition in a variety of modes analogous to current LCMS acquisition (e.g., MS^{E} using high and low collision energies as described above, using ion mobility as an orthogonal means of measurement along with MS). The time/desorption temperature at which an apex or peak ion intensity occurs will be the same for all ions related to the common desorbed component. That is, if the component desorbs at temperature T, then all ions related to that component will have their apex response at the same temperature T making it possible to identify associated time/temperature-aligned data for each component.

It should be noted that, the techniques described in preceding paragraphs and exemplary embodiments may be used with generally any sample or mixture of any complexity which may include small and/or large molecules. Such samples may include, for example, peptides, proteins, metabolites, lipids, pesticides, pharmaceuticals, natural products, and the like.

It should be noted that described herein are particular ways in which the techniques herein may be performed and those skilled in the art will appreciate that other suitable means may also be utilized in connection with performing techniques described herein. For example, described herein are examples of ways in which the sample undergoing analysis may be heated. More generally, the sample may be heated using other suitable means. For example, the sample on the surface which is heated such as described in connection with the probe embodiment may be heated by means of a laser. The laser may be used as the heat source applied to the surface including the sample to cause volatilization for use with techniques herein. To further illustrate, described above are exemplary embodiments in which a heated gas is used to heat a sample located on a surface to cause volatilization. Alternatively, another means by which the sample may be heated is to replace the heated gas stream with a laser as the heating source for use with the techniques described herein. In this manner, the laser may be characterized as, or otherwise included in, a means for thermal desorption that causes desorption of components in the sample. The laser may be controlled such as in an automated manner as described herein to provide different desorption temperatures varied over time in accordance with the thermal gradient in manner similar to that in which the heated gas is utilized.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A method of performing sample analysis comprising:
causing thermal desorption of components of the sample at atmospheric pressure at a plurality of times by applying one of a plurality of temperatures included in a temperature gradient at each of said plurality of times to a surface of said sample, wherein desorption of each of the components occurs at a different one of said plurality of temperatures thereby allowing differentiation of the components based on one of the plurality of times corresponding to the different one of the temperatures at which desorption occurs for said each component;
generating ions from said thermally desorbed components;
generating mass spectra from the ions; and
analyzing said mass spectra to determine mass spectral features about said components, wherein said analyzing includes associating one of the ions with one of said components if said one ion has an ion intensity apex or peak that is detected in the mass spectra and occurs at a first of the plurality of times corresponding to a first of the plurality of temperatures at which thermal desorption occurs for said one component.

2. The method of claim 1, further comprising:
determining that two of said ions are associated with one another and originate from the same component if said two ions have ion intensity peaks occurring at a same one of the plurality of times.

3. The method of claim 2, wherein said two ions have ion intensity peaks having similar shapes.

4. The method of claim 1, wherein said analyzing includes:
determining peaks in said mass spectra wherein each of said peaks corresponds to a detected ion of the sample, each of said peaks having associated identifying characteristics including an ion intensity, an m/z or mass, and one of said plurality of times corresponding to one of said plurality of temperatures at which said each peak is determined.

5. The method of claim 4, wherein said method includes performing ion mobility spectrometry and each of said peaks includes a measurement of said each peak in an ion mobility dimension.

6. The method of claim 1 wherein said mass spectra are uniformly sampled in time.

7. The method of claim 1, wherein said mass spectra are generated by perform mass spectrometry without performing a separation technique prior to said step of causing thermal desorption of components.

8. The method of claim 1, wherein said sample includes any of a complex mixture, a solid, a tissue, and a liquid.

9. The method of claim 1, wherein said sample includes one or more proteins, each of the proteins being identified by a first set of one or more precursor ions and a second set of one or more product ions generated from a precursor ion of the first set, wherein each of the ions in the first set and the second set has an ion intensity peak at a same one of the plurality of times corresponding to one of the plurality of temperatures.

10. The method of claim 1, wherein said thermal desorption is performed using an atmospheric pressure ionization technique.

11. The method of claim 10, wherein said atmospheric pressure ionization technique includes any of atmospheric pressure chemical ionization and atmospheric pressure photoionization.

12. The method of claim 1, wherein said thermal desorption is performed using a stream of a heated gas followed by subsequent ionization of desorbed components by means of a corona discharge established in a chamber in which a surface bearing the components is disposed.

13. The method of claim 1, wherein if a first component of the sample desorbs at a first of the plurality of temperatures, all ions originating from the component have an ion intensity peak or apex response at one of the plurality of times corresponding to the first temperature.

14. The method of claim 1, further comprising:
determining that a portion of said ions are related to one of the components wherein each ion of the portion has an ion intensity peak at a same one of the plurality of times.

15. The method of claim 1, wherein each of the components is desorbed in the time sequence at its characteristic temperature.

16. The method of claim 1, wherein said mass spectra are generated by performing analysis of said ions including performing mass spectrometry.

17. The method of claim 14, wherein ion mobility spectrometry is performed in connection with said ions prior to performing mass spectrometry.

18. The method of claim 1, wherein said plurality of temperatures of the thermal gradient define a range from a starting first temperature to an ending second temperature, wherein said first temperature is less than said second temperature and an exposed surface of said sample is subject to said plurality of temperatures from the starting first temperature at a first point in time to the ending second temperature at a second point in time subsequent to said first point in time.

19. The method of claim 1, wherein said plurality of temperatures of the thermal gradient define a range from a starting first temperature to an ending second temperature, wherein said first temperature is more than said second temperature and an exposed surface of said sample is subject to said plurality of temperatures from the starting first temperature at a first point in time to the ending second temperature at a second point in time subsequent to said first point in time.

20. The method of claim 1, wherein said thermal desorption is performed using a laser to cause desorption of components in the sample followed by subsequent ionization of desorbed components.

21. A system for sample analysis comprising:
means for causing thermal desorption of components of the sample at atmospheric pressure at a plurality of times by applying one of a plurality of temperatures included in a temperature gradient at each of said plurality of times to a surface of said sample, wherein desorption of each of the components occurs at a different one of said plurality of temperatures thereby allowing differentiation of the components based on one of the plurality of times corresponding to the different one of the temperatures at which desorption occurs for said each component;
means for generating ions from said thermally desorbed components;
means for generating mass spectra from the ions; and
means for analyzing said mass spectra to determine mass spectral features about said components, wherein analyzing said mass spectra includes associating one of the ions with one of said components if said one ion has an ion intensity apex or peak that is detected in the mass spectra and occurs at a first of the plurality of times corresponding to a first of the plurality of temperatures at which thermal desorption occurs for said one component.

22. The system of claim 21, wherein said means for thermal desorption causes desorption using a gas having its temperature varied over time in accordance with said thermal gradient.

23. The system of claim 21, wherein said means for generating ions uses an atmospheric pressure ionization technique.

24. The system of claim 21, wherein said means for generating mass spectra include a component that performs mass analysis.

25. The system of claim 24, wherein said means for generating mass spectra includes a component that perform ion mobility spectrometry prior to mass analysis.

26. The system of claim 21, further comprising means for introducing a sample for analysis.

27. The system of claim 26, wherein said means for introducing a sample includes any of a probe and a sample holder.

28. The system of claim 21, wherein said means for thermal desorption causes desorption using a laser to provide different desorption temperatures varied over time in accordance with said thermal gradient.
